(19) United States
(12) Patent Application Publication
(10) Pub. No.: US 2025/0205597 A1
(43) Pub. Date: Jun. 26, 2025

(54) OPTIMIZED MIXED REALITY AUDIO RENDERING

(71) Applicant: Magic Leap, Inc., Plantation, FL (US)

(72) Inventors: Mark Brandon HERTENSTEINER, San Jose, CA (US); Blaine Ivin WOOD, Eagle Mountain, UT (US); Michael Z. LAND, Mill Valley, CA (US); Remi Samuel AUDFRAY, San Francisco, CA (US); Jean-Marc JOT, Aptos, CA (US)

(73) Assignee: Magic Leap, Inc., Plantation, FL (US)

(21) Appl. No.: 18/848,482

(22) PCT Filed: Mar. 25, 2022
(86) PCT No.: PCT/US2022/071362

§ 371 Date: Sep. 18, 2024

(51) Int. Cl. A63F 13/54; G02B 27/01; G06F 3/16; G06T 19/00

(52) U.S. Cl. CPC A63F 13/54; G02B 27/017; G06F 3/16; G06T 19/006; A63F 2300/6081; G02B 2027/0178

(57) ABSTRACT

According to an example method, it is determined whether a difference between first acoustic data and second acoustic data exceeds a threshold. The first acoustic data is associated with a first client application in communication with an audio service. The second acoustic data is associated with a second client application. A first input audio signal associated with the first client application is received via the audio service. In accordance with the determination that the difference does not exceed the threshold, the second acoustic data is applied to the first input audio signal to produce a first output audio signal. In accordance with a determination that the difference exceeds the threshold, the first acoustic data is applied to the first input audio signal to produce the first output audio signal. The first output audio signal is presented to a user of a wearable head device in communication with the audio service.

### FIELD

This disclosure relates in general to systems and methods for managing, storing, and rendering audio data, and in particular to systems and methods for managing, and storing, and rendering audio data in a virtual reality, augmented reality, or mixed reality environment.

### BACKGROUND

Virtual environments are ubiquitous in computing environments, finding use in video games (in which a virtual environment may represent a game world); maps (in which a virtual environment may represent terrain to be navigated); simulations (in which a virtual environment may simulate a real environment); digital storytelling (in which virtual characters may interact with each other in a virtual environment); and many other applications. Modern computer users are generally comfortable perceiving, and interacting with, virtual environments. However, users' experiences with virtual environments can be limited by the technology for presenting virtual environments. For example, conventional displays (e.g., 2D display screens) and audio systems (e.g., fixed speakers) may be unable to realize a virtual environment in ways that create a compelling, realistic, and immersive experience.

Virtual reality (“VR”), augmented reality (“AR”), mixed reality (“MR”), and related technologies (collectively, “XR”) share an ability to present, to a user of an XR system, sensory information corresponding to a virtual environment represented by data in a computer system. Such systems can offer a uniquely heightened sense of immersion and realism by combining virtual visual and audio cues with real sights and sounds. Accordingly, it can be desirable to present digital sounds to a user of an XR system in such a way that the sounds seem to be occurring—naturally, and consistently with the user's expectations of the sound—in the user's real environment. Generally speaking, users expect that virtual sounds will take on the acoustic properties of the real environment in which they are heard. For instance, a user of an XR system in a large concert hall will expect the virtual sounds of the XR system to have large, cavernous sonic qualities; conversely, a user in a small apartment will expect the sounds to be more dampened, close, and immediate. In addition to matching virtual sounds with acoustic properties of a real and/or virtual environment, realism is further enhanced by spatializing virtual sounds. For example, a virtual object may visually fly past a user from behind, and the user may expect the corresponding virtual sound to similarly reflect the spatial movement of the virtual object with respect to the user.

XR client applications commonly need to present audio to a user. It is desirable for this audio to be qualitatively convincing to a user of an XR system. This includes presenting audio that is consistent with the user's expectations for audio in a virtual environment. It is common in modern XR systems for multiple client applications to be executed concurrently, such as by threads in a multithreaded computing environment. For example, a user of a augmented reality system may simultaneously be playing a game that features spatialized sound effects; using a telepresence application to communicate verbally with teammates in the game; using a menu system with non-spatialized sound effects; and using a music application to play background music. Examples of mixed reality audio for systems with multiple client applications are described in U.S. patent application Ser. No. 17/174,287 (“MULTI-APPLICATION AUDIO RENDERING”), which is incorporated herein by reference in its entirety.

However, some existing mixed reality audio systems exhibit certain disadvantages when rendering audio for multiple client applications. In some cases, these systems maintain a separate audio environment for each client application; while this permits each application to utilize an audio environment custom-suited to its own needs, this can be resource-intensive and does not scale well as the number of client applications increases. Additionally, some such systems present an audio experience that is poorly coordinated among different applications. For example, where multiple client applications do not share common audio components, such as components that describe a user's current room environment, audio may sound inconsistent across applications, as if the two applications do not exist in the same physical space. Another potential drawback is that per-client audio environments can place a heavy burden on the client application itself, which must handle audio processing tasks that could otherwise be shouldered by a central process.

Some systems try to address these problems by utilizing a shared audio environment for multiple client applications. However, while this can be more computationally efficient than maintaining audio environments on a per-client application basis, it may come at the cost of limiting flexible audio design for different applications. For instance, applications can lose the ability to customize audio parameters, or to present audio that is unique to one client application. Further, client applications may be unable to make changes to the audio environment without affecting other client applications. As a result, audio for a client application may sound bland and generic, or inconsistent with a visual presentation of that application (e.g., large virtual objects in a client application may not occlude that application's audio signals in the way a user would expect).

It is desirable to enable mixed reality audio systems that avoid the overhead of per-client audio environments, while still permitting client applications to present custom-tailored audio experiences. It is further desirable to manage audio environments in a manner that is transparent to client applications. It is further desirable to allow client applications to select, on a per-application basis, whether or not the application will be using shared acoustic data and/or whether or not the application will be using customized acoustic data. As described below, one way in which these goals can be obtained is by maintaining acoustic data for one or more client applications, but consolidating or reusing the acoustic data between two or more client applications if it would not result in a perceptually significant difference in an output audio signal.

### BRIEF SUMMARY

Systems and methods relating to rendering audio are disclosed. According to an example method, it is determined whether a difference between first acoustic data and second acoustic data exceeds a threshold. The first acoustic data is associated with a first client application in communication with an audio service. The second acoustic data is associated with a second client application in communication with the audio service. A first input audio signal associated with the first client application is received via the audio service. In accordance with the determination that the difference does not exceed the threshold, the second acoustic data is applied to the first input audio signal to produce a first output audio signal. In accordance with a determination that the difference exceeds the threshold, the first acoustic data is applied to the first input audio signal to produce the first output audio signal. The first output audio signal is presented to a user of a wearable head device in communication with the audio service.

### BRIEF DESCRIPTION OF THE DRAWINGS

FIGS. 1A-1C illustrate an example mixed reality environment, according to some embodiments.

FIGS. 2A-2D illustrate components of an example mixed reality system that can be used to generate and interact with a mixed reality environment, according to some embodiments.

FIG. 3A illustrates an example mixed reality handheld controller that can be used to provide input to a mixed reality environment, according to some embodiments.

FIG. 3B illustrates an example auxiliary unit that can be used with an example mixed reality system, according to some embodiments.

FIG. 4 illustrates an example functional block diagram for an example mixed reality system, according to some embodiments.

FIG. 5 illustrates examples of acoustic data structures, according to some embodiments.

FIG. 6 illustrates an example audio service, according to some embodiments.

FIG. 7 illustrates an example process for creating or modifying acoustic data, according to some embodiments.

FIG. 8 illustrates an example process for retrieving acoustic data, according to some embodiments.

FIG. 9 illustrates an example process for applying acoustic data to an audio signal, according to some embodiments.

FIG. 10 illustrates an example process for associating acoustic data with a client application, according to some embodiments.

FIG. 11 illustrates an example process for applying acoustic data to an audio signal, according to some embodiments.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

### Mixed Reality Environment

Like all people, a user of a mixed reality system exists in a real environment—that is, a three-dimensional portion of the “real world,” and all of its contents, that are perceptible by the user. For example, a user perceives a real environment using one's ordinary human senses—sight, sound, touch, taste, smell—and interacts with the real environment by moving one's own body in the real environment. Locations in a real environment can be described as coordinates in a coordinate space; for example, a coordinate can include latitude, longitude, and elevation with respect to sea level; distances in three orthogonal dimensions from a reference point; or other suitable values. Likewise, a vector can describe a quantity having a direction and a magnitude in the coordinate space.

A computing device can maintain, for example in a memory associated with the device, a representation of a virtual environment. As used herein, a virtual environment is a computational representation of a three-dimensional space. A virtual environment can include representations of any object, action, signal, parameter, coordinate, vector, or other characteristic associated with that space. In some examples, circuitry (e.g., a processor) of a computing device can maintain and update a state of a virtual environment; that is, a processor can determine at a first time t0, based on data associated with the virtual environment and/or input provided by a user, a state of the virtual environment at a second time t1. For instance, if an object in the virtual environment is located at a first coordinate at time t0, and has certain programmed physical parameters (e.g., mass, coefficient of friction); and an input received from user indicates that a force should be applied to the object in a direction vector; the processor can apply laws of kinematics to determine a location of the object at time t1 using basic mechanics. The processor can use any suitable information known about the virtual environment, and/or any suitable input, to determine a state of the virtual environment at a time t1. In maintaining and updating a state of a virtual environment, the processor can execute any suitable software, including software relating to the creation and deletion of virtual objects in the virtual environment; software (e.g., scripts) for defining behavior of virtual objects or characters in the virtual environment; software for defining the behavior of signals (e.g., audio signals) in the virtual environment; software for creating and updating parameters associated with the virtual environment; software for generating audio signals in the virtual environment; software for handling input and output; software for implementing network operations; software for applying asset data (e.g., animation data to move a virtual object over time); or many other possibilities.

Output devices, such as a display or a speaker, can present any or all aspects of a virtual environment to a user. For example, a virtual environment may include virtual objects (which may include representations of inanimate objects; people; animals; lights; etc.) that may be presented to a user. A processor can determine a view of the virtual environment (for example, corresponding to a “camera” with an origin coordinate, a view axis, and a frustum); and render, to a display, a viewable scene of the virtual environment corresponding to that view. Any suitable rendering technology may be used for this purpose. In some examples, the viewable scene may include only some virtual objects in the virtual environment, and exclude certain other virtual objects. Similarly, a virtual environment may include audio aspects that may be presented to a user as one or more audio signals. For instance, a virtual object in the virtual environment may generate a sound originating from a location coordinate of the object (e.g., a virtual character may speak or cause a sound effect); or the virtual environment may be associated with musical cues or ambient sounds that may or may not be associated with a particular location. A processor can determine an audio signal corresponding to a “listener” coordinate—for instance, an audio signal corresponding to a composite of sounds in the virtual environment, and mixed and processed to simulate an audio signal that would be heard by a listener at the listener coordinate—and present the audio signal to a user via one or more speakers.

Because a virtual environment exists only as a computational structure, a user cannot directly perceive a virtual environment using one's ordinary senses. Instead, a user can perceive a virtual environment only indirectly, as presented to the user, for example by a display, speakers, haptic output devices, etc. Similarly, a user cannot directly touch, manipulate, or otherwise interact with a virtual environment; but can provide input data, via input devices or sensors, to a processor that can use the device or sensor data to update the virtual environment. For example, a camera sensor can provide optical data indicating that a user is trying to move an object in a virtual environment, and a processor can use that data to cause the object to respond accordingly in the virtual environment.

A mixed reality system can present to the user, for example using a transmissive display and/or one or more speakers (which may, for example, be incorporated into a wearable head device), a mixed reality environment (“MRE”) that combines aspects of a real environment and a virtual environment. In some embodiments, the one or more speakers may be external to the head-mounted wearable unit. As used herein, a MRE is a simultaneous representation of a real environment and a corresponding virtual environment. In some examples, the corresponding real and virtual environments share a single coordinate space; in some examples, a real coordinate space and a corresponding virtual coordinate space are related to each other by a transformation matrix (or other suitable representation). Accordingly, a single coordinate (along with, in some examples, a transformation matrix) can define a first location in the real environment, and also a second, corresponding, location in the virtual environment; and vice versa.

In a MRE, a virtual object (e.g., in a virtual environment associated with the MRE) can correspond to a real object (e.g., in a real environment associated with the MRE). For instance, if the real environment of a MRE includes a real lamp post (a real object) at a location coordinate, the virtual environment of the MRE may include a virtual lamp post (a virtual object) at a corresponding location coordinate. As used herein, the real object in combination with its corresponding virtual object together constitute a “mixed reality object.” It is not necessary for a virtual object to perfectly match or align with a corresponding real object. In some examples, a virtual object can be a simplified version of a corresponding real object. For instance, if a real environment includes a real lamp post, a corresponding virtual object may include a cylinder of roughly the same height and radius as the real lamp post (reflecting that lamp posts may be roughly cylindrical in shape). Simplifying virtual objects in this manner can allow computational efficiencies, and can simplify calculations to be performed on such virtual objects. Further, in some examples of a MRE, not all real objects in a real environment may be associated with a corresponding virtual object. Likewise, in some examples of a MRE, not all virtual objects in a virtual environment may be associated with a corresponding real object. That is, some virtual objects may solely in a virtual environment of a MRE, without any real-world counterpart.

In some examples, virtual objects may have characteristics that differ, sometimes drastically, from those of corresponding real objects. For instance, while a real environment in a MRE may include a green, two-armed cactus—a prickly inanimate object—a corresponding virtual object in the MRE may have the characteristics of a green, two-armed virtual character with human facial features and a surly demeanor. In this example, the virtual object resembles its corresponding real object in certain characteristics (color, number of arms); but differs from the real object in other characteristics (facial features, personality). In this way, virtual objects have the potential to represent real objects in a creative, abstract, exaggerated, or fanciful manner; or to impart behaviors (e.g., human personalities) to otherwise inanimate real objects. In some examples, virtual objects may be purely fanciful creations with no real-world counterpart (e.g., a virtual monster in a virtual environment, perhaps at a location corresponding to an empty space in a real environment).

Compared to VR systems, which present the user with a virtual environment while obscuring the real environment, a mixed reality system presenting a MRE affords the advantage that the real environment remains perceptible while the virtual environment is presented. Accordingly, the user of the mixed reality system is able to use visual and audio cues associated with the real environment to experience and interact with the corresponding virtual environment. As an example, while a user of VR systems may struggle to perceive or interact with a virtual object displayed in a virtual environment—because, as noted above, a user cannot directly perceive or interact with a virtual environment—a user of a MR system may find it intuitive and natural to interact with a virtual object by seeing, hearing, and touching a corresponding real object in his or her own real environment. This level of interactivity can heighten a user's feelings of immersion, connection, and engagement with a virtual environment. Similarly, by simultaneously presenting a real environment and a virtual environment, mixed reality systems can reduce negative psychological feelings (e.g., cognitive dissonance) and negative physical feelings (e.g., motion sickness) associated with VR systems. Mixed reality systems further offer many possibilities for applications that may augment or alter our experiences of the real world.

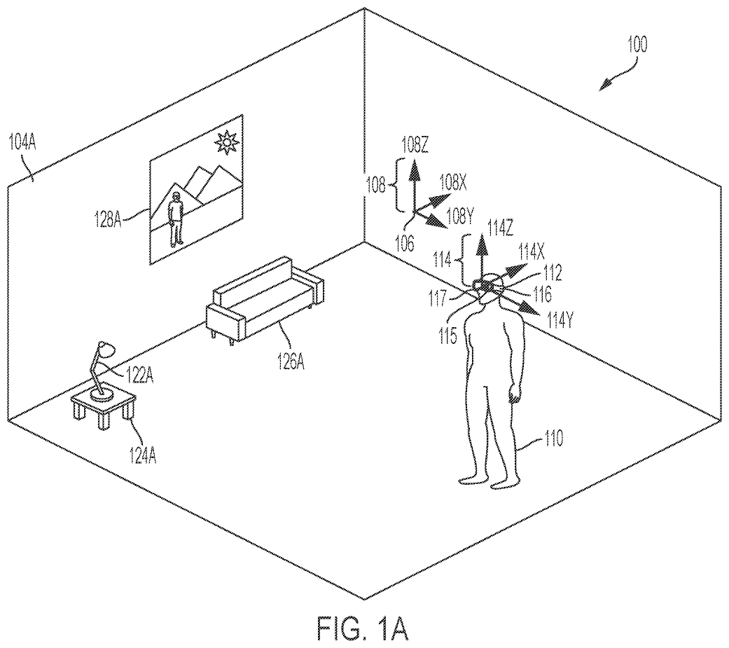

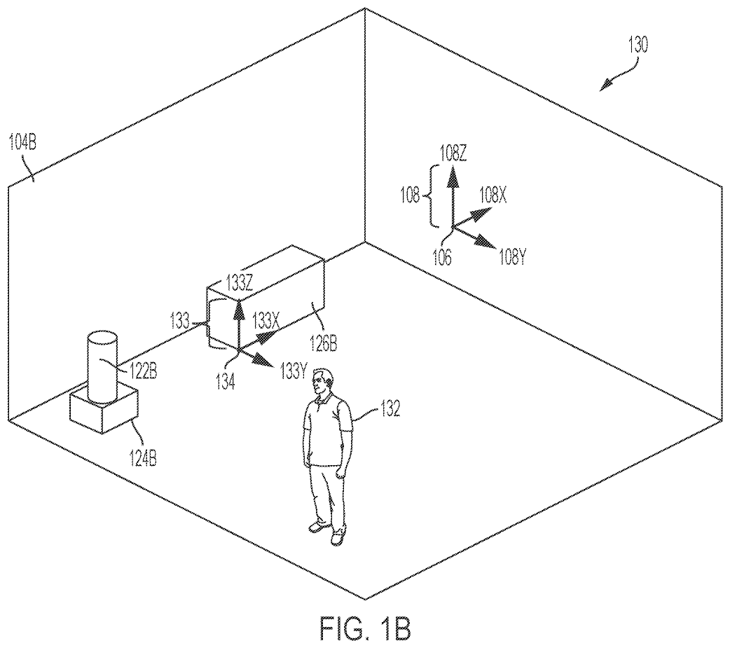

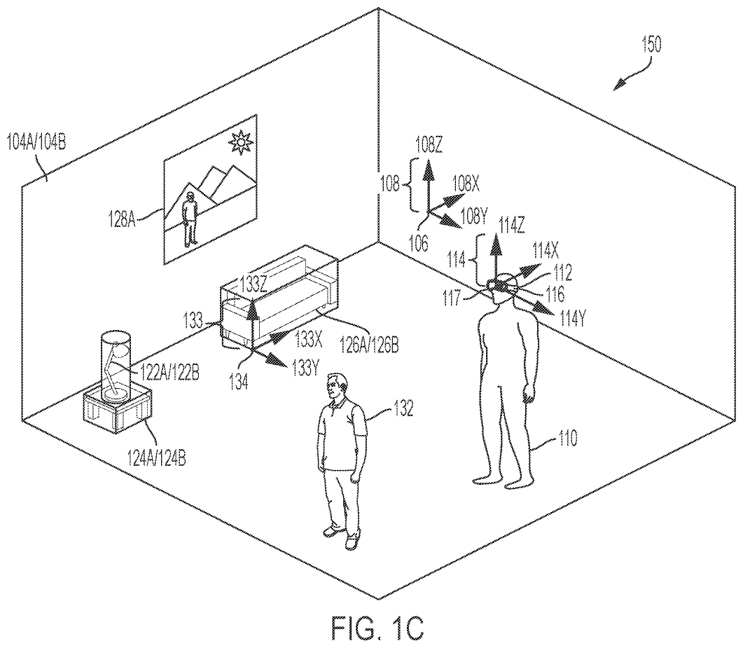

FIG. 1A illustrates an example real environment 100 in which a user 110 uses a mixed reality system 112. Mixed reality system 112 may include a display (e.g., a transmissive display) and one or more speakers, and one or more sensors (e.g., a camera), for example as described below. The real environment 100 shown includes a rectangular room 104A, in which user 110 is standing; and real objects 122A (a lamp), 124A (a table), 126A (a sofa), and 128A (a painting). Room 104A further includes a location coordinate 106, which may be considered an origin of the real environment 100. As shown in FIG. 1A, an environment/world coordinate system 108 (comprising an x-axis 108X, a y-axis 108Y, and a z-axis 108Z) with its origin at point 106 (a world coordinate), can define a coordinate space for real environment 100. In some embodiments, the origin point 106 of the environment/world coordinate system 108 may correspond to where the mixed reality system 112 was powered on. In some embodiments, the origin point 106 of the environment/world coordinate system 108 may be reset during operation. In some examples, user 110 may be considered a real object in real environment 100; similarly, user 110's body parts (e.g., hands, feet) may be considered real objects in real environment 100. In some examples, a user/listener/head coordinate system 114 (comprising an x-axis 114X, a y-axis 114Y, and a z-axis 114Z) with its origin at point 115 (e.g., user/listener/head coordinate) can define a coordinate space for the user/listener/head on which the mixed reality system 112 is located. The origin point 115 of the user/listener/head coordinate system 114 may be defined relative to one or more components of the mixed reality system 112. For example, the origin point 115 of the user/listener/head coordinate system 114 may be defined relative to the display of the mixed reality system 112 such as during initial calibration of the mixed reality system 112. A matrix (which may include a translation matrix and a Quaternion matrix or other rotation matrix), or other suitable representation can characterize a transformation between the user/listener/head coordinate system 114 space and the environment/world coordinate system 108 space. In some embodiments, a left ear coordinate 116 and a right ear coordinate 117 may be defined relative to the origin point 115 of the user/listener/head coordinate system 114. A matrix (which may include a translation matrix and a Quaternion matrix or other rotation matrix), or other suitable representation can characterize a transformation between the left ear coordinate 116 and the right ear coordinate 117, and user/listener/head coordinate system 114 space. The user/listener/head coordinate system 114 can simplify the representation of locations relative to the user's head, or to a head-mounted device, for example, relative to the environment/world coordinate system 108. Using Simultaneous Localization and Mapping (SLAM), visual odometry, or other techniques, a transformation between user coordinate system 114 and environment coordinate system 108 can be determined and updated in real-time.

FIG. 1B illustrates an example virtual environment 130 that corresponds to real environment 100. The virtual environment 130 shown includes a virtual rectangular room 104B corresponding to real rectangular room 104A; a virtual object 122B corresponding to real object 122A; a virtual object 124B corresponding to real object 124A; and a virtual object 126B corresponding to real object 126A. Metadata associated with the virtual objects 122B, 124B, 126B can include information derived from the corresponding real objects 122A, 124A, 126A. Virtual environment 130 additionally includes a virtual monster 132, which does not correspond to any real object in real environment 100. Real object 128A in real environment 100 does not correspond to any virtual object in virtual environment 130. A persistent coordinate system 133 (comprising an x-axis 133X, a y-axis 133Y, and a z-axis 133Z) with its origin at point 134 (persistent coordinate), can define a coordinate space for virtual content. The origin point 134 of the persistent coordinate system 133 may be defined relative/with respect to one or more real objects, such as the real object 126A. A matrix (which may include a translation matrix and a Quaternion matrix or other rotation matrix), or other suitable representation can characterize a transformation between the persistent coordinate system 133 space and the environment/world coordinate system 108 space. In some embodiments, each of the virtual objects 122B, 124B, 126B, and 132 may have their own persistent coordinate point relative to the origin point 134 of the persistent coordinate system 133. In some embodiments, there may be multiple persistent coordinate systems and each of the virtual objects 122B, 124B, 126B, and 132 may have their own persistent coordinate point relative to one or more persistent coordinate systems.

With respect to FIGS. 1A and 1B, environment/world coordinate system 108 defines a shared coordinate space for both real environment 100 and virtual environment 130. In the example shown, the coordinate space has its origin at point 106. Further, the coordinate space is defined by the same three orthogonal axes (108X, 108Y, 108Z). Accordingly, a first location in real environment 100, and a second, corresponding location in virtual environment 130, can be described with respect to the same coordinate space. This simplifies identifying and displaying corresponding locations in real and virtual environments, because the same coordinates can be used to identify both locations. However, in some examples, corresponding real and virtual environments need not use a shared coordinate space. For instance, in some examples (not shown), a matrix (which may include a translation matrix and a Quaternion matrix or other rotation matrix), or other suitable representation can characterize a transformation between a real environment coordinate space and a virtual environment coordinate space.

FIG. 1C illustrates an example MRE 150 that simultaneously presents aspects of real environment 100 and virtual environment 130 to user 110 via mixed reality system 112. In the example shown, MRE 150 simultaneously presents user 110 with real objects 122A, 124A, 126A, and 128A from real environment 100 (e.g., via a transmissive portion of a display of mixed reality system 112); and virtual objects 122B, 124B, 126B, and 132 from virtual environment 130 (e.g., via an active display portion of the display of mixed reality system 112). As above, origin point 106 acts as an origin for a coordinate space corresponding to MRE 150, and coordinate system 108 defines an x-axis, y-axis, and z-axis for the coordinate space.

In the example shown, mixed reality objects include corresponding pairs of real objects and virtual objects (i.e., 122A/122B, 124A/124B, 126A/126B) that occupy corresponding locations in coordinate space 108. In some examples, both the real objects and the virtual objects may be simultaneously visible to user 110. This may be desirable in, for example, instances where the virtual object presents information designed to augment a view of the corresponding real object (such as in a museum application where a virtual object presents the missing pieces of an ancient damaged sculpture). In some examples, the virtual objects (122B, 124B, and/or 126B) may be displayed (e.g., via active pixelated occlusion using a pixelated occlusion shutter) so as to occlude the corresponding real objects (122A, 124A, and/or 126A). This may be desirable in, for example, instances where the virtual object acts as a visual replacement for the corresponding real object (such as in an interactive storytelling application where an inanimate real object becomes a “living” character).

In some examples, real objects (e.g., 122A, 124A, 126A) may be associated with virtual content or helper data that may not necessarily constitute virtual objects. Virtual content or helper data can facilitate processing or handling of virtual objects in the mixed reality environment. For example, such virtual content could include two-dimensional representations of corresponding real objects; custom asset types associated with corresponding real objects; or statistical data associated with corresponding real objects. This information can enable or facilitate calculations involving a real object without incurring unnecessary computational overhead.

In some examples, the presentation described above may also incorporate audio aspects. For instance, in MRE 150, virtual monster 132 could be associated with one or more audio signals, such as a footstep sound effect that is generated as the monster walks around MRE 150. As described further below, a processor of mixed reality system 112 can compute an audio signal corresponding to a mixed and processed composite of all such sounds in MRE 150, and present the audio signal to user 110 via one or more speakers included in mixed reality system 112 and/or one or more external speakers.

### Example Mixed Reality System

Example mixed reality system 112 can include a wearable head device (e.g., a wearable augmented reality or mixed reality head device) comprising a display (which may include left and right transmissive displays, which may be near-eye displays, and associated components for coupling light from the displays to the user's eyes); left and right speakers (e.g., positioned adjacent to the user's left and right ears, respectively); an inertial measurement unit (IMU) (e.g., mounted to a temple arm of the head device); an orthogonal coil electromagnetic receiver (e.g., mounted to the left temple piece); left and right cameras (e.g., depth (time-of-flight) cameras) oriented away from the user; and left and right eye cameras oriented toward the user (e.g., for detecting the user's eye movements). However, a mixed reality system 112 can incorporate any suitable display technology, and any suitable sensors (e.g., optical, infrared, acoustic, LIDAR, EOG, GPS, magnetic). In addition, mixed reality system 112 may incorporate networking features (e.g., Wi-Fi capability) to communicate with other devices and systems, including other mixed reality systems. Mixed reality system 112 may further include a battery (which may be mounted in an auxiliary unit, such as a belt pack designed to be worn around a user's waist), a processor, and a memory. The wearable head device of mixed reality system 112 may include tracking components, such as an IMU or other suitable sensors, configured to output a set of coordinates of the wearable head device relative to the user's environment. In some examples, tracking components may provide input to a processor performing a Simultaneous Localization and Mapping (SLAM) and/or visual odometry algorithm. In some examples, mixed reality system 112 may also include a handheld controller 300, and/or an auxiliary unit 320, which may be a wearable beltpack, as described further below.

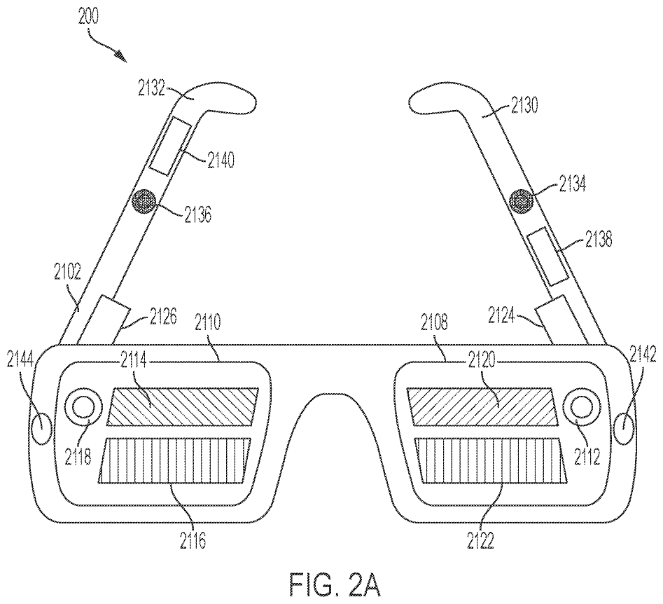

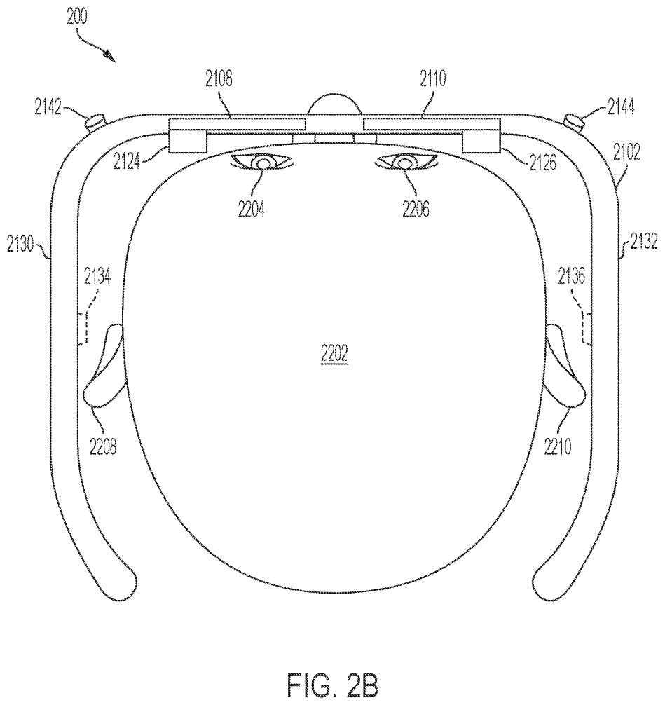

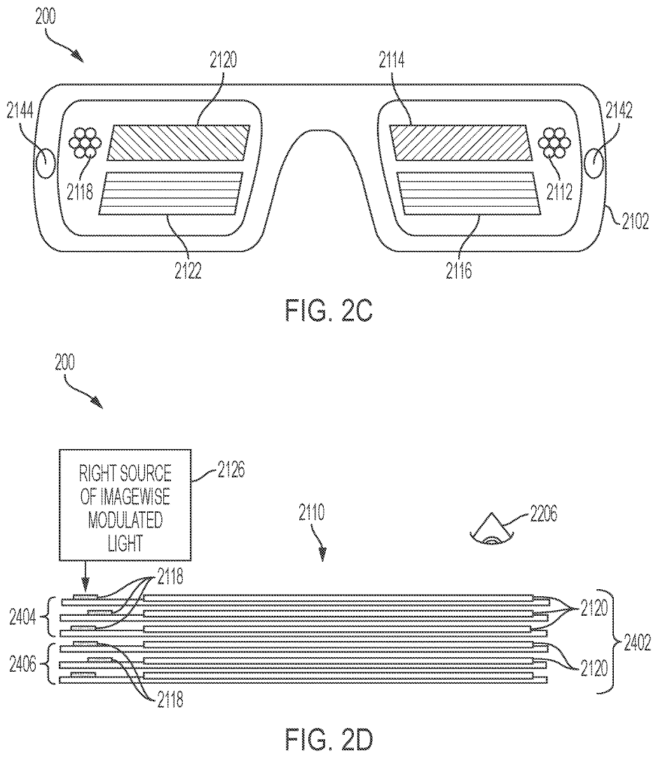

FIGS. 2A-2D illustrate components of an example mixed reality system 200 (which may correspond to mixed reality system 112) that may be used to present a MRE (which may correspond to MRE 150), or other virtual environment, to a user. FIG. 2A illustrates a perspective view of a wearable head device 2102 included in example mixed reality system 200. FIG. 2B illustrates a top view of wearable head device 2102 worn on a user's head 2202. FIG. 2C illustrates a front view of wearable head device 2102. FIG. 2D illustrates an edge view of example eyepiece 2110 of wearable head device 2102. As shown in FIGS. 2A-2C, the example wearable head device 2102 includes an example left eyepiece (e.g., a left transparent waveguide set eyepiece) 2108 and an example right eyepiece (e.g., a right transparent waveguide set eyepiece) 2110. Each eyepiece 2108 and 2110 can include transmissive elements through which a real environment can be visible, as well as display elements for presenting a display (e.g., via imagewise modulated light) overlapping the real environment. In some examples, such display elements can include surface diffractive optical elements for controlling the flow of imagewise modulated light. For instance, the left eyepiece 2108 can include a left incoupling grating set 2112, a left orthogonal pupil expansion (OPE) grating set 2120, and a left exit (output) pupil expansion (EPE) grating set 2122. Similarly, the right eyepiece 2110 can include a right incoupling grating set 2118, a right OPE grating set 2114 and a right EPE grating set 2116. Imagewise modulated light can be transferred to a user's eye via the incoupling gratings 2112 and 2118, OPEs 2114 and 2120, and EPE 2116 and 2122. Each incoupling grating set 2112, 2118 can be configured to deflect light toward its corresponding OPE grating set 2120, 2114. Each OPE grating set 2120, 2114 can be designed to incrementally deflect light down toward its associated EPE 2122, 2116, thereby horizontally extending an exit pupil being formed. Each EPE 2122, 2116 can be configured to incrementally redirect at least a portion of light received from its corresponding OPE grating set 2120, 2114 outward to a user eyebox position (not shown) defined behind the eyepieces 2108, 2110, vertically extending the exit pupil that is formed at the eyebox. Alternatively, in lieu of the incoupling grating sets 2112 and 2118, OPE grating sets 2114 and 2120, and EPE grating sets 2116 and 2122, the eyepieces 2108 and 2110 can include other arrangements of gratings and/or refractive and reflective features for controlling the coupling of imagewise modulated light to the user's eyes.

In some examples, wearable head device 2102 can include a left temple arm 2130 and a right temple arm 2132, where the left temple arm 2130 includes a left speaker 2134 and the right temple arm 2132 includes a right speaker 2136. An orthogonal coil electromagnetic receiver 2138 can be located in the left temple piece, or in another suitable location in the wearable head unit 2102. An Inertial Measurement Unit (IMU) 2140 can be located in the right temple arm 2132, or in another suitable location in the wearable head device 2102. The wearable head device 2102 can also include a left depth (e.g., time-of-flight) camera 2142 and a right depth camera 2144. The depth cameras 2142, 2144 can be suitably oriented in different directions so as to together cover a wider field of view.

In the example shown in FIGS. 2A-2D, a left source of imagewise modulated light 2124 can be optically coupled into the left eyepiece 2108 through the left incoupling grating set 2112, and a right source of imagewise modulated light 2126 can be optically coupled into the right eyepiece 2110 through the right incoupling grating set 2118. Sources of imagewise modulated light 2124, 2126 can include, for example, optical fiber scanners; projectors including electronic light modulators such as Digital Light Processing (DLP) chips or Liquid Crystal on Silicon (LCoS) modulators; or emissive displays, such as micro Light Emitting Diode (μLED) or micro Organic Light Emitting Diode (μOLED) panels coupled into the incoupling grating sets 2112, 2118 using one or more lenses per side. The input coupling grating sets 2112, 2118 can deflect light from the sources of imagewise modulated light 2124, 2126 to angles above the critical angle for Total Internal Reflection (TIR) for the eyepieces 2108, 2110. The OPE grating sets 2114, 2120 incrementally deflect light propagating by TIR down toward the EPE grating sets 2116, 2122. The EPE grating sets 2116, 2122 incrementally couple light toward the user's face, including the pupils of the user's eyes.

In some examples, as shown in FIG. 2D, each of the left eyepiece 2108 and the right eyepiece 2110 includes a plurality of waveguides 2402. For example, each eyepiece 2108, 2110 can include multiple individual waveguides, each dedicated to a respective color channel (e.g., red, blue and green). In some examples, each eyepiece 2108, 2110 can include multiple sets of such waveguides, with each set configured to impart different wavefront curvature to emitted light. The wavefront curvature may be convex with respect to the user's eyes, for example to present a virtual object positioned a distance in front of the user (e.g., by a distance corresponding to the reciprocal of wavefront curvature). In some examples, EPE grating sets 2116, 2122 can include curved grating grooves to effect convex wavefront curvature by altering the Poynting vector of exiting light across each EPE.

In some examples, to create a perception that displayed content is three-dimensional, stereoscopically-adjusted left and right eye imagery can be presented to the user through the imagewise light modulators 2124, 2126 and the eyepieces 2108, 2110. The perceived realism of a presentation of a three-dimensional virtual object can be enhanced by selecting waveguides (and thus corresponding the wavefront curvatures) such that the virtual object is displayed at a distance approximating a distance indicated by the stereoscopic left and right images. This technique may also reduce motion sickness experienced by some users, which may be caused by differences between the depth perception cues provided by stereoscopic left and right eye imagery, and the autonomic accommodation (e.g., object distance-dependent focus) of the human eye.

FIG. 2D illustrates an edge-facing view from the top of the right eyepiece 2110 of example wearable head device 2102. As shown in FIG. 2D, the plurality of waveguides 2402 can include a first subset of three waveguides 2404 and a second subset of three waveguides 2406. The two subsets of waveguides 2404, 2406 can be differentiated by different EPE gratings featuring different grating line curvatures to impart different wavefront curvatures to exiting light. Within each of the subsets of waveguides 2404, 2406 each waveguide can be used to couple a different spectral channel (e.g., one of red, green and blue spectral channels) to the user's right eye 2206. (Although not shown in FIG. 2D, the structure of the left eyepiece 2108 is analogous to the structure of the right eyepiece 2110.)

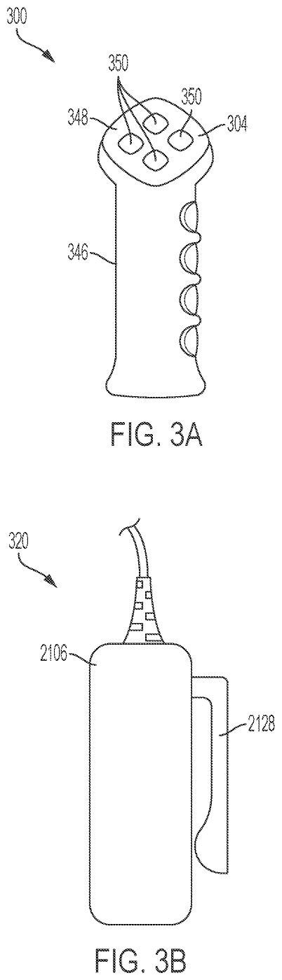

FIG. 3A illustrates an example handheld controller component 300 of a mixed reality system 200. In some examples, handheld controller 300 includes a grip portion 346 and one or more buttons 350 disposed along a top surface 348. In some examples, buttons 350 may be configured for use as an optical tracking target, e.g., for tracking six-degree-of-freedom (6DOF) motion of the handheld controller 300, in conjunction with a camera or other optical sensor (which may be mounted in a head unit (e.g., wearable head device 2102) of mixed reality system 200). In some examples, handheld controller 300 includes tracking components (e.g., an IMU or other suitable sensors) for detecting position or orientation, such as position or orientation relative to wearable head device 2102. In some examples, such tracking components may be positioned in a handle of handheld controller 300, and/or may be mechanically coupled to the handheld controller. Handheld controller 300 can be configured to provide one or more output signals corresponding to one or more of a pressed state of the buttons; or a position, orientation, and/or motion of the handheld controller 300 (e.g., via an IMU). Such output signals may be used as input to a processor of mixed reality system 200. Such input may correspond to a position, orientation, and/or movement of the handheld controller (and, by extension, to a position, orientation, and/or movement of a hand of a user holding the controller). Such input may also correspond to a user pressing buttons 350.

FIG. 3B illustrates an example auxiliary unit 320 of a mixed reality system 200. The auxiliary unit 320 can include a battery to provide energy to operate the system 200, and can include a processor for executing programs to operate the system 200. As shown, the example auxiliary unit 320 includes a clip 2128, such as for attaching the auxiliary unit 320 to a user's belt. Other form factors are suitable for auxiliary unit 320 and will be apparent, including form factors that do not involve mounting the unit to a user's belt. In some examples, auxiliary unit 320 is coupled to the wearable head device 2102 through a multiconduit cable that can include, for example, electrical wires and fiber optics. Wireless connections between the auxiliary unit 320 and the wearable head device 2102 can also be used.

In some examples, mixed reality system 200 can include one or more microphones to detect sound and provide corresponding signals to the mixed reality system. In some examples, a microphone may be attached to, or integrated with, wearable head device 2102, and may be configured to detect a user's voice. In some examples, a microphone may be attached to, or integrated with, handheld controller 300 and/or auxiliary unit 320. Such a microphone may be configured to detect environmental sounds, ambient noise, voices of a user or a third party, or other sounds.

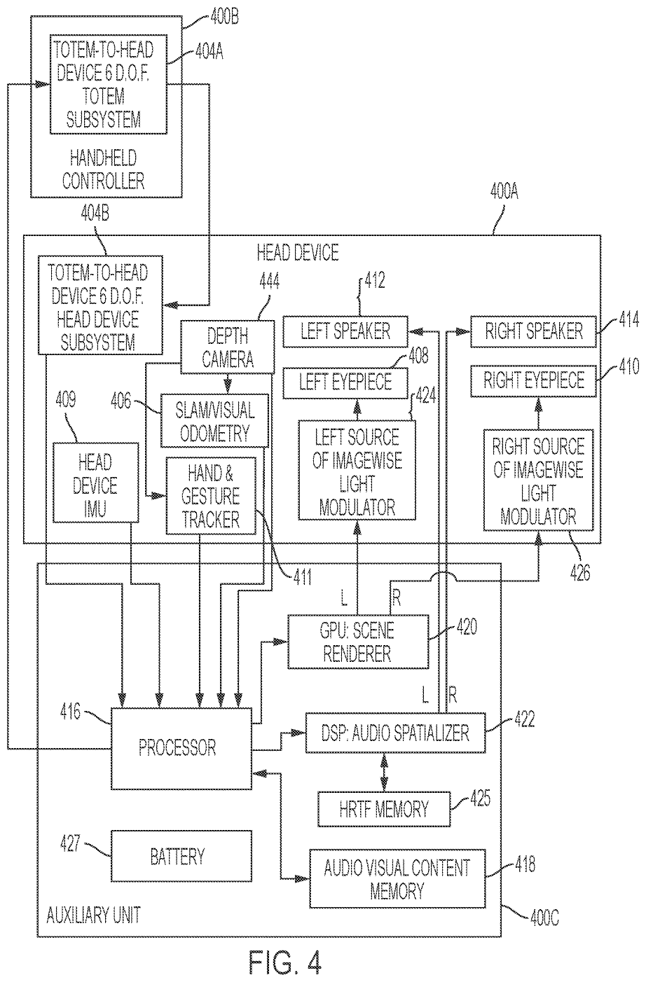

FIG. 4 shows an example functional block diagram that may correspond to an example mixed reality system, such as mixed reality system 200 described above (which may correspond to mixed reality system 112 with respect to FIG. 1). As shown in FIG. 4, example handheld controller 400B (which may correspond to handheld controller 300 (a “totem”)) includes a totem-to-wearable head device six degree of freedom (6DOF) totem subsystem 404A and example wearable head device 400A (which may correspond to wearable head device 2102) includes a totem-to-wearable head device 6DOF subsystem 404B. In the example, the 6DOF totem subsystem 404A and the 6DOF subsystem 404B cooperate to determine six coordinates (e.g., offsets in three translation directions and rotation along three axes) of the handheld controller 400B relative to the wearable head device 400A. The six degrees of freedom may be expressed relative to a coordinate system of the wearable head device 400A. The three translation offsets may be expressed as X, Y, and Z offsets in such a coordinate system, as a translation matrix, or as some other representation. The rotation degrees of freedom may be expressed as sequence of yaw, pitch and roll rotations, as a rotation matrix, as a quaternion, or as some other representation. In some examples, the wearable head device 400A; one or more depth cameras 444 (and/or one or more non-depth cameras) included in the wearable head device 400A; and/or one or more optical targets (e.g., buttons 350 of handheld controller 400B as described above, or dedicated optical targets included in the handheld controller 400B) can be used for 6DOF tracking. In some examples, the handheld controller 400B can include a camera, as described above; and the wearable head device 400A can include an optical target for optical tracking in conjunction with the camera. In some examples, the wearable head device 400A and the handheld controller 400B each include a set of three orthogonally oriented solenoids which are used to wirelessly send and receive three distinguishable signals. By measuring the relative magnitude of the three distinguishable signals received in each of the coils used for receiving, the 6DOF of the wearable head device 400A relative to the handheld controller 400B may be determined. Additionally, 6DOF totem subsystem 404A can include an Inertial Measurement Unit (IMU) that is useful to provide improved accuracy and/or more timely information on rapid movements of the handheld controller 400B.

In some examples, it may become necessary to transform coordinates from a local coordinate space (e.g., a coordinate space fixed relative to the wearable head device 400A) to an inertial coordinate space (e.g., a coordinate space fixed relative to the real environment), for example in order to compensate for the movement of the wearable head device 400A relative to the coordinate system 108. For instance, such transformations may be necessary for a display of the wearable head device 400A to present a virtual object at an expected position and orientation relative to the real environment (e.g., a virtual person sitting in a real chair, facing forward, regardless of the wearable head device's position and orientation), rather than at a fixed position and orientation on the display (e.g., at the same position in the right lower corner of the display), to preserve the illusion that the virtual object exists in the real environment (and does not, for example, appear positioned unnaturally in the real environment as the wearable head device 400A shifts and rotates). In some examples, a compensatory transformation between coordinate spaces can be determined by processing imagery from the depth cameras 444 using a SLAM and/or visual odometry procedure in order to determine the transformation of the wearable head device 400A relative to the coordinate system 108. In the example shown in FIG. 4, the depth cameras 444 are coupled to a SLAM/visual odometry block 406 and can provide imagery to block 406. The SLAM/visual odometry block 406 implementation can include a processor configured to process this imagery and determine a position and orientation of the user's head, which can then be used to identify a transformation between a head coordinate space and another coordinate space (e.g., an inertial coordinate space). Similarly, in some examples, an additional source of information on the user's head pose and location is obtained from an IMU 409. Information from the IMU 409 can be integrated with information from the SLAM/visual odometry block 406 to provide improved accuracy and/or more timely information on rapid adjustments of the user's head pose and position.

In some examples, the depth cameras 444 can supply 3D imagery to a hand gesture tracker 411, which may be implemented in a processor of the wearable head device 400A. The hand gesture tracker 411 can identify a user's hand gestures, for example by matching 3D imagery received from the depth cameras 444 to stored patterns representing hand gestures. Other suitable techniques of identifying a user's hand gestures will be apparent.

In some examples, one or more processors 416 may be configured to receive data from the wearable head device's 6DOF headgear subsystem 404B, the IMU 409, the SLAM/visual odometry block 406, depth cameras 444, and/or the hand gesture tracker 411. The processor 416 can also send and receive control signals from the 6DOF totem system 404A. The processor 416 may be coupled to the 6DOF totem system 404A wirelessly, such as in examples where the handheld controller 400B is untethered. Processor 416 may further communicate with additional components, such as an audio-visual content memory 418, a Graphical Processing Unit (GPU) 420, and/or a Digital Signal Processor (DSP) audio spatializer 422. The DSP audio spatializer 422 may be coupled to a Head Related Transfer Function (HRTF) memory 425. The GPU 420 can include a left channel output coupled to the left source of imagewise modulated light 424 and a right channel output coupled to the right source of imagewise modulated light 426. GPU 420 can output stereoscopic image data to the sources of imagewise modulated light 424, 426, for example as described above with respect to FIGS. 2A-2D. The DSP audio spatializer 422 can output audio to a left speaker 412 and/or a right speaker 414. The DSP audio spatializer 422 can receive input from processor 419 indicating a direction vector from a user to a virtual sound source (which may be moved by the user, e.g., via the handheld controller 320). Based on the direction vector, the DSP audio spatializer 422 can determine a corresponding HRTF (e.g., by accessing a HRTF, or by interpolating multiple HRTFs). The DSP audio spatializer 422 can then apply the determined HRTF to an audio signal, such as an audio signal corresponding to a virtual sound generated by a virtual object. This can enhance the believability and realism of the virtual sound, by incorporating the relative position and orientation of the user relative to the virtual sound in the mixed reality environment—that is, by presenting a virtual sound that matches a user's expectations of what that virtual sound would sound like if it were a real sound in a real environment.

In some examples, such as shown in FIG. 4, one or more of processor 416, GPU 420, DSP audio spatializer 422, HRTF memory 425, and audio/visual content memory 418 may be included in an auxiliary unit 400C (which may correspond to auxiliary unit 320 described above). The auxiliary unit 400C may include a battery 427 to power its components and/or to supply power to the wearable head device 400A or handheld controller 400B. Including such components in an auxiliary unit, which can be mounted to a user's waist, can limit the size and weight of the wearable head device 400A, which can in turn reduce fatigue of a user's head and neck.

While FIG. 4 presents elements corresponding to various components of an example mixed reality system, various other suitable arrangements of these components will become apparent to those skilled in the art. For example, elements presented in FIG. 4 as being associated with auxiliary unit 400C could instead be associated with the wearable head device 400A or handheld controller 400B. Furthermore, some mixed reality systems may forgo entirely a handheld controller 400B or auxiliary unit 400C. Such changes and modifications are to be understood as being included within the scope of the disclosed examples.

### Mixed Reality Audio

As described above, a MRE (such as experienced via a mixed reality system, e.g., mixed reality system 112, which may include components such as a wearable head unit 200, handheld controller 300, or auxiliary unit 320 described above) can present audio signals that appear, to a user of the MRE, to originate at a sound source with an origin coordinate in the MRE. That is, the user may perceive these audio signals as if they are real audio signals originating from the origin coordinate of the sound source.

In some cases, audio signals may be considered virtual in that they correspond to computational signals in a virtual environment. Virtual audio signals can be presented to a user as real audio signals detectable by the human ear, for example as generated via speakers 2134 and 2136 of wearable head unit 200 in FIG. 2.

A sound source may correspond to a real object and/or a virtual object. For example, a virtual object (e.g., virtual monster 132 of FIG. 1C) can emit an audio signal in a MRE, which is represented in the MRE as a virtual audio signal, and presented to the user as a real audio signal. For instance, virtual monster 132 of FIG. 1C can emit a virtual sound corresponding to the monster's speech (e.g., dialogue) or sound effects. Similarly, a real object (e.g., real object 122A of FIG. 1C) can be made to appear to emit a virtual audio signal in a MRE, which is represented in the MRE as a virtual audio signal, and presented to the user as a real audio signal. For instance, real lamp 122A can emit a virtual sound corresponding to the sound effect of the lamp being switched on or off—even if the lamp is not being switched on or off in the real environment. The virtual sound can correspond to a position and orientation of the sound source (whether real or virtual). For instance, if the virtual sound is presented to the user as a real audio signal (e.g., via speakers 2134 and 2136), the user may perceive the virtual sound as originating from the position of the sound source. Sound sources are referred to herein as “virtual sound sources,” even though the underlying object made to apparently emit a sound may itself correspond to a real or virtual object, such as described above.

Some virtual or mixed reality environments suffer from a perception that the environments do not feel real or authentic. One reason for this perception is that audio and visual cues do not always match each other in such environments. For example, if a user is positioned behind a large brick wall in a MRE, the user may expect sounds coming from behind the brick wall to be quieter and more muffled than sounds originating right next to the user. This expectation is based on the user's auditory experiences in the real world, where sounds become quiet and muffled when they pass behind large, dense objects. When the user is presented with an audio signal that purportedly originates from behind the brick wall, but that is presented unmuffled and at full volume, the illusion that the sound originates from behind the brick wall is compromised. The entire virtual experience may feel fake and inauthentic, in part because it does not comport with the user's expectations based on real world interactions. Further, in some cases, an “uncanny valley” problem arises, in which even subtle differences between virtual experiences and real experiences can cause heightened feelings of discomfort. It is desirable to improve the user's experience by presenting, in a MRE, audio signals that appear to realistically interact—even in subtle ways—with objects in the user's environment. The more consistent that such audio signals are with the user's expectations, based on real world experience, the more immersive and engaging the user's experience in the MRE can be.

One way that users perceive and understand the environment around them is through audio cues. In the real world, the real audio signals users hear are affected by where those audio signals originate from and what objects that audio signals interact with. For example, with all other factors equal, a sound that originates a great distance from a user (e.g., a dog barking in the distance) will appear quieter than the same sound originating from a short distance from the user (e.g., the dog barking in the same room as the user). A user can thus identify a location of a dog in the real environment based in part on the perceived volume of its bark. Likewise, with all other factors equal, a sound that travels away from the user (e.g., the voice of a person who is facing away from the user) will appear less clear and more muffled (e.g., low-pass filtered) than the same sound traveling toward the user (e.g., the voice of a person who is facing toward the user). A user can thus identify the orientation of a person in the real environment based on the perceived characteristics of that person's voice.

A user's perception of real audio signals can also be affected by the presence of objects in the environment with which audio signals interact. That is, a user may perceive not only an audio signal generated by a sound source, but also the reflections of that audio signal against nearby objects and the reverberation signature imparted by the surrounding acoustic space. For example, if a person speaks in a small room with close walls, those walls may cause short, natural reverberated signals to result as the person's voice reflects off of the walls. A user may infer from those reverberations that they are in a small room with close walls. Likewise, a large concert hall or cathedral may cause longer reverberations, from which the user may infer that they are in a large, spacious room. Similarly, reverberations of audio signals may take on various sonic characteristics based on the position or orientation of the surfaces against which those signals reflect, or the materials of those surfaces. For example, reverberations against tiled walls will sound different than reverberations against brick, carpet, drywall, or other materials. These reverberation characteristics can be used by the user to understand—acoustically—the size, shape, and material composition of the space they inhabit.

The above examples illustrate how audio cues can inform a user's perception of the environment around them. These cues can act in combination with visual cues: for example, if the user sees a dog in the distance, the user may expect the sound of that dog's bark to be consistent with that distance (and may feel disconcerted or disoriented if it is not, as in some virtual environments). In some examples, such as in low-light environments, or with respect to visually impaired users, visual cues may be limited or unavailable; in such cases, audio cues may take on a particular importance, and may serve as the user's primary means of understanding their environment.

A system architecture may be beneficial to organize, store, recall, and/or manage information needed to present realistic virtual audio. For example, a MR system (e.g., MR system 112, 200) may manage environmental information like what real environment a user may be in, what acoustic properties that real environment may have, and/or where in that real environment the user may be located. A MR system may further manage information regarding objects in the real and/or virtual environment (e.g., objects that may affect the general acoustic properties of a real environment and/or objects that may affect acoustic properties of a virtual sound source interacting with the objects). A MR system may also manage information regarding virtual sound sources. For example, where a virtual sound source is located may be relevant in rendering realistic virtual audio.

In addition to managing a virtual audio system, it may be necessary to manage other systems simultaneously to present a full MR experience. For example, a full MR experience may require a virtual visuals system, which may manage information used to render virtual objects. A full MR experience may require a simultaneous localization and mapping system (“SLAM”), which may construct, update, and/or maintain a three-dimensional model of a user's environment. A MR system (e.g., MR system 112, 200) may manage these systems and more, in addition to a virtual audio system, to present a full MR experience. A virtual audio system architecture may be helpful to manage interactions between these systems to facilitate data transfer, management, storage, and/or security.

In some embodiments, a system (e.g., a virtual audio system) may interact with higher-level systems, such as client applications. Client applications may be applications, services, modules, or other processes. For example, a client application can include a game application; a voice, chat, video, or telepresence application; a menu system; a user interface module; a multimedia application; an internet browser; or any other suitable application. Some client applications (such as augmented reality games) may interact directly with virtual environments, including virtual geometry or other objects within a virtual environment, such as described above with respect to FIGS. 1A-1C. However, some client applications (such as applications that play non-spatialized music tracks, or menu systems that present non-spatialized sound effects) need not interact with virtual environments, even if those applications are in use by a user of a MR system. In some embodiments, client applications can be executed by one or more processors of a MR system (e.g., MR system 112, 200). In some embodiments, client applications can be executed by one or more remote processors in communication with the MR system.

Each client application may have its own specific audio needs. For example, some client applications may benefit from making use of shared audio data maintained by the MR system, while others may not. For instance, audio for a client application may include a combination of area-based audio (e.g., reverberation that is dependent on the geometry of a physical space) and object based audio (e.g., audio filtering that results from the placement of a virtual object between a sound source and a listener). In some embodiments, the MR system maintains a shared set of acoustic data for use across multiple client applications. The shared set of acoustic data can be referred to as an “acoustic map.” The shared acoustic data can represent area-based audio effects that are functions of a current mixed reality environment. For example, the shared acoustic data can comprise reverberation parameters based on the dimensions and surface materials of a room. These area-based effects may be a natural fit for shared acoustic data that is common to multiple client applications. Because they are based on a current environment (i.e., an environment based on the user's current location), they are likely to remain consistent across applications. That is, many applications will wish to use audio parameters (such as reverberation parameters) that are representative of the user's current environment, and also consistent with other applications that are running concurrently. These applications can achieve those advantages by utilizing shared acoustic data.

In some embodiments, the MR system maintains acoustic data on a per-client application basis. This client application acoustic data can be referred to as an “acoustic scene.” The client application acoustic data can include, for example, object-based audio effects that are functions of virtual objects in a current mixed reality environment. For instance, a client application may add or delete its own virtual objects (e.g., game elements such as walls or barriers in a mixed reality game) that are not present or applicable to other client applications. It may be desirable for these virtual objects to affect the audio in that particular client application, while leaving audio for other client applications unaffected. Virtual objects can affect audio by, for example, applying filtering to audio signals to create the impression that the audio signal is being occluded by the virtual object. In addition, client application acoustic data can include audio effects for virtual surface materials, acoustic bodies, acoustic regions, rooms, room linkages, and other suitable characteristics for a client application.

In embodiments, each client application can be associated with runtime acoustic data. The runtime acoustic data is used by a rendering engine to process an audio signal for a client application. The runtime acoustic data can be referred to as an “acoustic model.”

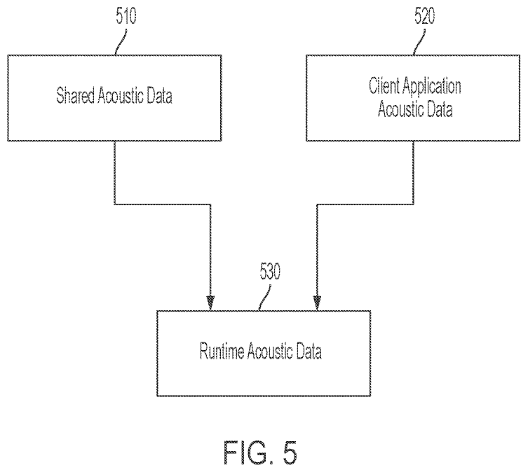

FIG. 5 shows an example of acoustic data structures such as described above. In the figure, 530 represents an example of runtime acoustic data, such as described above. Runtime acoustic data 530 can be applied to an input audio signal to render an output audio signal. Runtime acoustic data 530 can comprise a default set of runtime acoustic data, or can comprise runtime acoustic data that is specific to a client application. As shown in the figure, runtime acoustic data 530 can be based on one or more of shared acoustic data 510 and client application acoustic data 520. As described above, shared acoustic data 510 can comprise acoustic data for a virtual environment that is maintained on a shared or global basis and can be reused by multiple client applications. Shared acoustic data 510 can represent acoustic characteristics that belong to a current environment of a user, such as a room or acoustic region in which the user is currently located. In some embodiments, shared acoustic data 510 can be in a non-runtime format. In some embodiments, shared acoustic data 510 can be in a runtime format.

As described above, client application acoustic data 520 can comprise acoustic data that is specific to a client application and maintained on a per-client application basis. The client application acoustic data can represent virtual objects, or other elements, that are specific to a client application. In some cases, the client application acoustic data can override some or all of the shared acoustic data 510. For example, shared acoustic data 510 might specify a set of reverberation parameters for an acoustic space, based on the dimensions of that space; but it might be desirable for a particular client application to override those reverberation parameters for creative effect, in a way that does not affect other client applications (which may use the reverberation parameters specified by acoustic data 510). In some embodiments, client application acoustic data 520 can be in a non-runtime format. In some embodiments, client application acoustic data 520 can be in a runtime format.

Any of runtime acoustic data 530, shared acoustic data 510, and client application acoustic data 520 can include information about acoustic objects, characteristics of a virtual environment, properties relevant to sound propagation, and/or other suitable acoustic information. Properties relevant to sound propagation can include reflectivity or transmission characteristics; acoustic zone descriptors; reverberation properties; or other suitable information.

In some embodiments, shared acoustic data 510 may be associated with a physical location (such as a GPS location), or a set of such locations. For example, one or more sensors of a wearable device can determine a current location of the wearable device, and retrieve a set of shared acoustic data 510 associated with that location. Similarly, client application acoustic data 520 can depend on a current location of a user. Examples of retrieving acoustic data based on a user's location are described in U.S. patent application Ser. No. 16/163,529 (“MIXED REALITY SPATIAL AUDIO”), which is incorporated herein by reference in its entirety. In some embodiments, shared acoustic data 510 may be used by multiple wearable devices. Additionally, in some embodiments, client application acoustic data 520 or runtime acoustic data 530 may be used by multiple wearable devices.

In some wearable device embodiments, any or all of runtime acoustic data 530, shared acoustic data 510, and client application acoustic data 520 can be generated by and/or stored on the wearable device itself. In some embodiments, any or all of runtime acoustic data 530, shared acoustic data 510, and client application acoustic data 520 can be generated and/or stored remotely and retrieved by the wearable device.

In examples where a client application uses both shared acoustic data 510 and client application acoustic data 520, the runtime acoustic data 530 for that client application can incorporate elements of shared acoustic data 510 and client application acoustic data 520. For example, if shared acoustic data 510 represents reverberation parameters for the user's current acoustic region, and client application acoustic data 520 represents filtering parameters for a large virtual object, such as a wall, runtime acoustic data 530 can represent both the reverberation parameters for the acoustic region (from 510) and the filtering parameters for the virtual object (from 520).

In some embodiments, client applications need not use the shared acoustic data 510, and further need not use the client application acoustic data 520. If a client application does not use an acoustic data set, such as shared acoustic data 510 or client application acoustic data 520, those data sets can be replace with default acoustic data sets (which in some cases may have a neutral acoustic effect). In some embodiments, whether to use a shared acoustic data 510 or a client application acoustic data 520 can be specified on a per-application basis, such as by setting one or more flags (or other variables) for the application.

In some embodiments, a client application may be associated with a runtime acoustic model (such as 530) that is unrelated to a shared acoustic data 510 or a client application acoustic data 520. In some embodiments, the runtime acoustic model can comprise a default set of acoustic data; can comprise custom acoustic data; can be retrieved from a database of acoustic data; or can be determined by any suitable technique.

In some embodiments, an audio service can be used in connection with acoustic data such as that described above. An audio service can comprise one or more processes executed by one or more processors, such as a general-purpose processor or a specialized audio processor (such as a DSP). In some wearable device embodiments, the audio service processes can be executed by one or more processors of the wearable device itself (e.g., processor 416 or DSP 422 as shown in FIG. 4); or by one or more processors external to the wearable device and in communication with the wearable device (such as a server, or device in a peer-to-peer network with the wearable device). The audio service can be in communication with one or more client applications, which can provide acoustic data and/or audio signals to the audio service. In some cases, the client applications can include a plugin that handles communication between the client application and the audio service. The audio service can present to a user an output audio signal, such as an output audio signal produced via an audio rendering engine. The audio service can also be in communication with a repository of acoustic data, such as a database storing acoustic data for retrieval by the audio service.

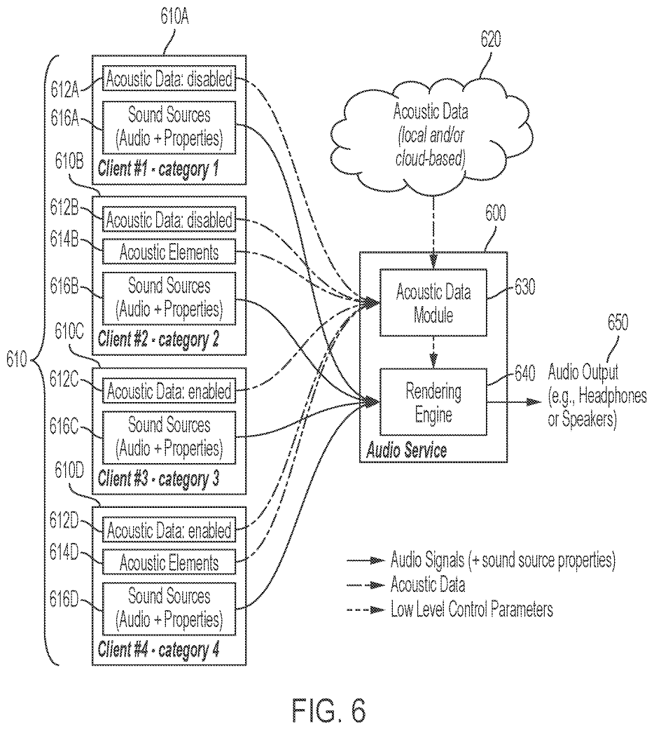

FIG. 6 shows an example of an audio service 600, according to some embodiments. In some embodiments, audio service 600 can be an audio service in communication with a wearable device, such as an MR system, such as described above. In some embodiments, audio service 600 can correspond to an audio service such as described in U.S. patent application Ser. No. 17/174,287 (“MULTI-APPLICATION AUDIO RENDERING”). (For example, audio service 600 may correspond to the audio service 522 described in that application.) In the example shown in the figure, audio service 600 comprises an acoustic scene module 630, described further below, and a rendering engine 640. However, in some embodiments, audio service 600 need not include acoustic scene module 630 and need not include rendering engine 640. In some examples, audio service 600 may be in communication with an acoustic scene module 630 that is external to audio service 600, and/or in communication with a rendering engine 640 that is external to audio service 600.

Acoustic scene module 630 can provide control parameters to rendering engine 640. Rendering engine 640 can render an output audio signal 650 based on an input audio signal and one or more control parameters, which can include control parameters received from acoustic scene module 630. These control parameters can include low level parameters that are used to control processes of rendering engine 640. Rendering engine 640 may correspond to a rendering layer such as described in U.S. patent application Ser. No. 17/174,287 (“MULTI-APPLICATION AUDIO RENDERING”). For example, rendering engine 640 can include one or more of a direct layer, a reflections layer, a reverberation layer, and a virtualizer, such as described in U.S. patent application Ser. No. 17/174,287 with respect to rendering layer 902 in that application.

In the example shown in the figure, audio service 600 is in communication with acoustic data storage 620. Acoustic data storage 620 can provide acoustic data to audio service 600 (e.g., to acoustic scene module 630 of audio service 600). Acoustic data storage 620 can be a storage medium (such as a memory, a hard disk, an optical disc, or other suitable storage medium) that stores acoustic data such as runtime acoustic data 530 described above. In some embodiments, acoustic data storage 620 can be local to audio service 600. In some embodiments, acoustic data storage may be a storage medium, such as a network server or a cloud-based service, that is remote to audio service 600. In the example shown, an output of audio service 600 (e.g., an output of rendering engine 640) is an output audio signal 650. In some examples, output audio signal 650 can be presented to a user via speakers of a wearable device (e.g., headphones of a wearable head device), or via any other suitable sound reproduction mechanism. In some examples, output audio signal 650 can be presented as an input signal to another process. Output audio signal 650 can comprise waveform audio, compressed audio, or audio data in any suitable format.

In the figure, audio service 600 is in communication with client applications 610 (which include client applications 610A, 610B, 610C, and 610D). While four example client applications are shown in the example in the figure, client applications 610 can include any suitable number of client applications. Further, some or all of client applications 610 may execute concurrently.

One or more of client applications 610 can include a process executing on a wearable device (e.g., via processor 416 or DSP 422 as shown in FIG. 4). The wearable device may be in communication with audio service 600. One or more of client applications 610 can include a process executing on one or more processors external to a wearable device and in communication with the wearable device (such as a server, or a device in a peer-to-peer network with the wearable device). As shown in the figure, each of client applications 610 can provide audio signals and/or sound source properties to audio service 600 (e.g., to a rendering engine 640 of audio service 600). Moreover, each of client applications 610 can provide acoustic data to audio service 600 (e.g., to an acoustic scene module 630 of audio service 600). Client applications 610 can also provide other data as appropriate.

Each of client applications 610 can be associated with a set of acoustic data, e.g., runtime acoustic data 530, as described above. A set of acoustic data for a client application can be used by audio service 600 (e.g., by rendering engine 640) to render audio signals provided by the client application. Sets of acoustic data can be stored in acoustic data storage 620 for retrieval by audio service 600 (e.g., by acoustic scene module 630) as described below.

In some embodiments, each of client applications 610 can specify, on a per-client application basis, aspects of its associated acoustic data. As described above with respect to FIG. 5, runtime acoustic data 530 (which may be called an acoustic model) can be based on one or more of shared acoustic data 510 (which may be called an acoustic map) and client application acoustic data 520 (which may be called an acoustic scene). Client applications can individually specify whether to utilize shared acoustic data 510 and/or client application acoustic data 520. For example, in the figure, each of client applications 610 includes a data member (612A, 612B, 612C, 612D) that specifies whether the respective client application uses shared acoustic data 510 (e.g., whether the shared acoustic data is enabled or disabled). As shown in the example, client applications 610C and 610D specify that they use shared acoustic data 510, while client applications 610A and 610B specify that they do not. Similarly, in the figure, client applications 610B and 610D include acoustic elements that are specific to their respective client application. These acoustic elements can correspond to client application acoustic data 520 described above. For instance, acoustic elements 614B can describe acoustic data that is specific to client application 610B; and acoustic elements 614D can describe acoustic data that is specific to client application 610D. In embodiments, audio service 600 can check for the presence of this client application acoustic data, on a per-application basis, which identifies that runtime acoustic data 530 for that client application data should be based on client application acoustic data for the corresponding client application. Conversely, client applications 610A and 610C do not include acoustic elements. This indicates that runtime acoustic data 530 for these client applications are not based on any client application acoustic data. (In some examples, default acoustic data can be used in place of client application acoustic data.)

In the above example, client application 610A represents a client application that does not use global acoustic data, and does not contribute any client application acoustic data of its own. For client application 610A, a default set of runtime acoustic data may be applied to render audio for this application. An example of an application that may use this approach is a menu system that features only non-spatialized sound effects.

In the above example, client application 610B represents a client application that does not use global acoustic data, but that contributes its own client application acoustic data. For client application 610B, runtime acoustic data will not utilize any shared acoustic data (such as reverberation parameters that correspond to the user's current acoustic space), and the client application can supply acoustic data to create its own customized audio environment. An example of an application that may use this approach is a fantasy or science fiction game in which game sounds deviate heavily from the user's actual acoustic environment for creative effect.

In the above example, client application 610C represents a client application that uses global acoustic data, and does not contribute any client application acoustic data of its own. For client application 610C, runtime acoustic data can use shared acoustic data (such as reverberation parameters that correspond to the user's current acoustic space), without any additional client application acoustic data specific to the client application. An example of an application that may use this approach is an augmented reality “tour guide” application that guides a user through a physical space, such as a museum. While it may be important for the application's audio to be consistent with the acoustic characteristics of the physical space (which can be captured in the global acoustic data), the application may have no application-specific audio needs that would require additional acoustic data.

In the above example, client application 610D represents a client application that uses global acoustic data, and additionally contributes client application acoustic data of its own. For client application 610D, runtime acoustic data can use shared acoustic data (such as reverberation parameters that correspond to the user's current acoustic space), and can also incorporate client application acoustic data specific to the client application. An example of an application that may use this approach is an architectural visualization application that allows the user to add virtual walls, surfaces, objects, or other geometry to an existing physical space. It may be important for the application's audio to be consistent not only with the acoustic characteristics of the physical space (which can be captured in the global acoustic data), but also with the virtual content added by the application.

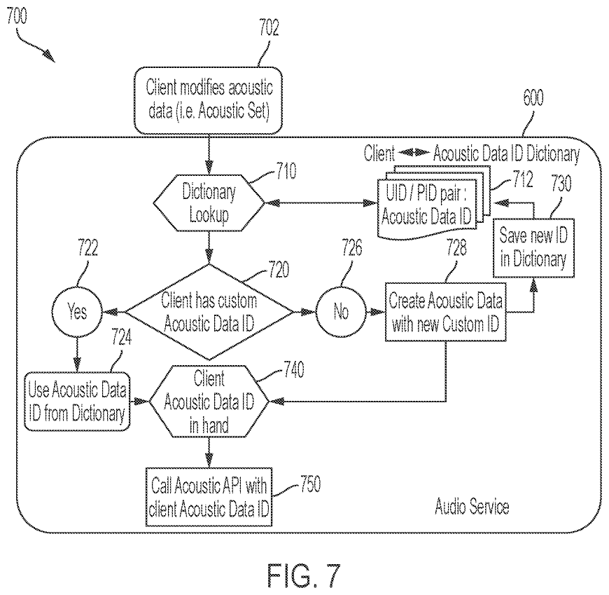

In some embodiments, an audio service permits a client application to create, modify, or reset acoustic data. FIG. 7 shows an example process 700 in which acoustic data is created or modified for a client application. In the example shown, the process can be performed by audio service 600, but in some embodiments, one or more steps of process 700 can be performed by another suitable service or process. In the example, audio service 600 receives an indication 702 that a client application, such as one of client applications 610, is attempting to create or modify acoustic data. This can be referred to as a “set” operation with respect to the acoustic data. In some embodiments, the indication 702 can be received via a API, a user interface (including a GUI), or another suitable interface. The indication 702 can directly or indirectly identify a set of acoustic data. In some embodiments, the acoustic data can comprise an acoustic scene (i.e., client application acoustic data 520 as described above). An acoustic scene can be associated with a unique acoustic scene ID, which can be identified directly or indirectly by indication 702. In some embodiments, the acoustic data can comprise an acoustic model (i.e., runtime acoustic data 530 as described above). An acoustic model can be associated with a unique acoustic model ID. In some embodiments, an acoustic scene can be uniquely associated with an acoustic model. In such embodiments, an acoustic model ID can be the same as an acoustic scene ID.

In the example, upon receiving indication 702, audio service 600 performs a dictionary lookup 710, which can identify acoustic data (e.g., client application acoustic data 520, or runtime acoustic data 530) from a dictionary 712 that stores associations of acoustic data with client applications. For example, dictionary 712 can comprise a database (or other suitable data structure) that identifies, for a client process or a client application (e.g., a client ID or a process ID), associated acoustic data. At stage 720, audio service 600 can determine whether acoustic data identified by indication 702 corresponds to custom acoustic data in dictionary 712. If so (722), audio service 600 retrieves the acoustic data (724). If the acoustic data does not correspond to custom acoustic data in dictionary 712 (726), audio service 600 can create new acoustic data for the client application (728) and save it to the dictionary 712 (730). With the acoustic data in memory (740), audio service can call audio API functions based on the acoustic data (750), or otherwise process the acoustic data, or interact with rendering engine 640 based on the acoustic data. In embodiments where acoustic data is runtime acoustic data, the acoustic data can be used to render audio signals (such as audio signals communicated to audio service 600 by a client application) for output.

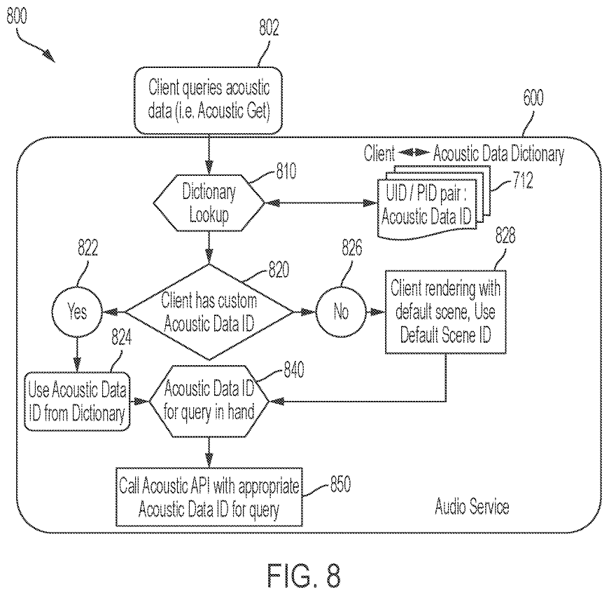

FIG. 8 shows an example process 800 in which acoustic data is retrieved for a client application. In the example shown, the process can be performed by audio service 600, but in some embodiments, one or more steps of process 800 can be performed by another suitable service or process. In the example, audio service 600 receives an indication 802 that a client application, such as one of client applications 610, is attempting to retrieve acoustic data. This can be referred to as a “get” operation with respect to the acoustic data. In some embodiments, the indication 802 can be received via an API, a user interface (including a GUI), or another suitable interface. The indication 802 can directly or indirectly identify a set of acoustic data. In some embodiments, the acoustic data can comprise an acoustic scene (e.g., client application acoustic data 520 as described above). An acoustic scene can be associated with a unique acoustic scene ID, which can be identified directly or indirectly by indication 802. In some embodiments, the acoustic data can comprise an acoustic model (i.e., runtime acoustic data 530 as described above). An acoustic model can be associated with a unique acoustic model ID. In some embodiments, an acoustic scene can be uniquely associated with an acoustic model. In such embodiments, an acoustic model ID can be the same as an acoustic scene ID. An acoustic model ID and/or an acoustic scene ID can be referred to as an acoustic data ID.

In the example, upon receiving indication 802, audio service 600 performs a dictionary lookup 810, which can identify a set of acoustic data (e.g., client application acoustic data 520, or runtime acoustic data 530) from a dictionary 712, such as described above with respect to FIG. 7, that stores associations of acoustic data with client applications. For example, as described above, dictionary 712 can comprise a database (or other suitable data structure) that identifies, for a client process or a client application (e.g., a client ID or a process ID), associated acoustic data. At stage 820, audio service 600 can determine whether acoustic data identified by indication 802 corresponds to a custom acoustic data in dictionary 712. If so (822), audio service 600 retrieves the acoustic data (824). If the acoustic data does not correspond to a custom acoustic scene in dictionary 712 (826), audio service 600 can use default acoustic data for audio rendering for this client application (828). With the acoustic data in memory (840), audio service can call audio API functions based on the acoustic data (850), or otherwise process the acoustic data, or interact with rendering engine 640 based on the acoustic data. In embodiments where acoustic data is runtime acoustic data, the acoustic data can be used to render audio signals (such as audio signals communicated to audio service 600 by a client application) for output.

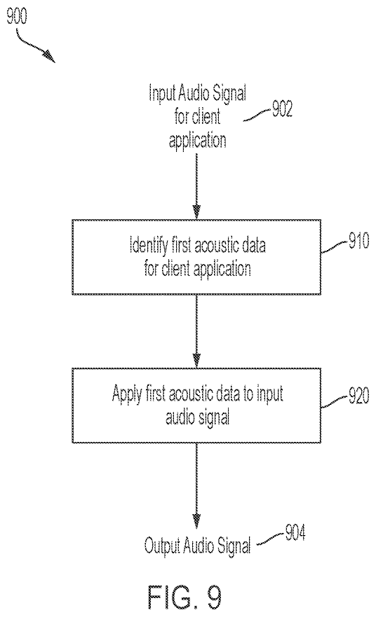

FIG. 9 shows an example process 900 in which acoustic data (which can correspond to runtime acoustic data 530) is applied at runtime to an input audio signal associated with a client application to produce an output audio signal. In some examples, process 900 may be performed in whole or in part by audio service 600. In some examples, process 900 may be performed in whole or in part by a rendering engine, such as rendering engine 640, which may be a part of audio service 600. In the example process, an input audio signal 902 is received. Input audio signal 902 is associated with a client application, such as one of client applications 610 described above with respect to FIG. 6. In some embodiments, input audio signal 902 is received at audio service 600 from the client application; for example, FIG. 6 shows that audio signals (such as input audio signal 902) and sound source properties may be presented to audio service 600 (e.g., at rendering engine 640) directly by the client application. At stage 910, first acoustic data (such as runtime acoustic data 530) is identified for the client application. Examples of identifying the acoustic data for a client application are described above with respect to FIG. 7 and FIG. 8 and processes 700 and 800. At stage 920, the first acoustic data is applied to the input audio signal 902 to produce an output audio signal 904, which may correspond to audio output 650 in FIG. 6. Stage 920 can be performed by audio service 600, by rendering engine 640 (which may belong to audio service 600), or by some other suitable process. In some embodiments, output audio signal 904 can be presented to a user, such as a user of a wearable device via speakers or headphones of the wearable device.

Process 900 can be executed for multiple input audio signals, such as multiple input audio signals associated with multiple client applications (e.g., client applications 610). The multiple client applications may be multiple client applications of a wearable device, such as a head-worn augmented reality or mixed reality system. Process 900 can be executed concurrently for some or all of the input audio signals.

Stage 920 can be a computationally intensive process, and performing process 900 for multiple input audio signals can be computationally taxing, or may be prohibitive for more than a certain number of client applications. For example, as described above, such as with respect to FIG. 6, each client application can be associated with a unique set of acoustic data. Rendering audio concurrently for multiple input audio signals (e.g., one input audio signal from each of multiple client applications), based on a different set of acoustic data for each of the input audio signals, can be more resource intensive than rendering audio for the multiple input signals based on fewer sets of acoustic data. Audio rendering for multiple client applications can thus be optimized, such as described below, by reducing the amount of distinct acoustic data that is utilized in the rendering process.

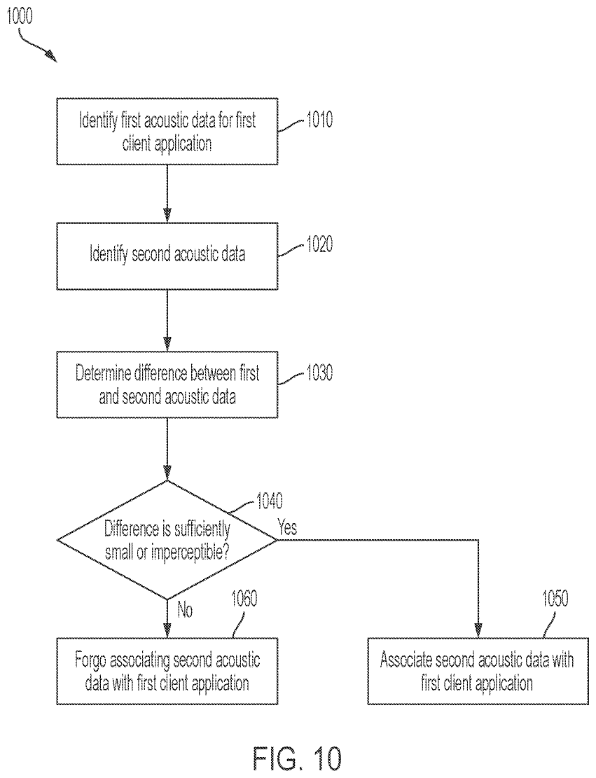

FIG. 10 shows an example process 1000 in which acoustic data is associated with a client application. Process 1000 can be performed by audio service 600, by an acoustic data module 630, by rendering engine 640, or by any other suitable process. In some embodiments, process 1000 is performed by a processor of a wearable device, such as a wearable head device for an augmented reality or mixed reality system.

According to some embodiments, at stage 1010, first acoustic data is identified for a first client application. For example, the first client application may correspond to one of client applications 610 in FIG. 6. Audio service 600 can identify first acoustic data for the first client application according to the example processes 700 or 800 described above, or according to another suitable process. The first acoustic data can correspond to runtime acoustic data 530 or client application acoustic data 520, described above. The first acoustic data can be identified via acoustic data storage 620, which may include local storage and/or remote storage. In some embodiments, a dictionary (such as dictionary 712) can be used to identify an association between the first client application and the first acoustic data.

At stage 1020, second acoustic data is identified. In some embodiments, the second acoustic data may be associated with a second client application (e.g., one of client applications 610 in FIG. 6). In some embodiments, the second acoustic data need not be associated with a client application. The second acoustic data can be identified via acoustic data storage 620, such as described above. In some embodiments, a dictionary (such as dictionary 712) can be used to identify the second acoustic data.

At stage 1030, a difference can be computed between the first acoustic data and the second acoustic data. If the difference between the first acoustic data and the second acoustic data is sufficiently small, or sufficiently imperceptible (stage 1040), then the first client application can be associated with the second acoustic data (stage 1050), such that the second acoustic data (rather than the first acoustic data) can be used to render an audio signal of the first client application. If the difference between the first acoustic data and the second acoustic data is not sufficiently small, or is not sufficiently imperceptible, then the first client application is not associated with the second acoustic data (stage 1060), and the first acoustic data (which is associated with the first client application) can be used to render an audio signal of the first client application.

Conversely, in some embodiments, process 1000 can determine a similarity between the first and second acoustic data at stage 1030, and if the similarity is sufficiently large (1040), the first client application can be associated with the second acoustic data (1050). In some embodiments, the association between the first client application and the second acoustic data can be made and stored via dictionary 712, as described above with respect to processes 700 and 800. If the similarity is not sufficiently large (1040), then the process can forgo associating the first client application with the second acoustic data (1060). Other variations of process 1000 will be apparent to the skilled artisan and are within the scope of this disclosure.

Compared to audio rendering where unique acoustic data is applied to each of multiple client applications (e.g., first, second, and third client applications), process 1000 can enable optimized audio rendering with lower computational overhead. For instance, as described above, the second acoustic data may be associated with a second client application. If audio signals from the first client application are rendered using the first acoustic data, and audio signals from the second client application are rendered using the second acoustic data, then two sets of acoustic data are required, with relatively high overhead. However, if in process 1000, the first client application is associated with the second acoustic data (stage 1050), while the second client application is also associated with the second acoustic data, then audio signals from both the first client application and the second client application can be rendered using the same set of acoustic data (the second acoustic data). This will allow the audio signals to be rendered with lower overhead than if each client application remained associated with its unique acoustic data. Further efficiencies can be gained if process 1000 is applied to additional client applications, such as the client applications 610A, 610B, 610C, and 610D shown with respect to FIG. 6.

In some embodiments, process 1000 can be performed as a runtime process, such as while an input audio signal is received from the first client application. In some embodiments, process 1000 can be performed as a non-runtime process, such as at a time before an input audio signal is received from the first client application.

Various approaches can be used to determine a difference between the first and second acoustic data at stage 1030. In some embodiments, determining the difference comprises identifying one or more parameters for each of the first and second acoustic data, and determining a numerical difference between the parameters of the first acoustic data and the corresponding parameters of the second acoustic data. The numerical difference can comprise any appropriate measurement of a difference, including any statistical approach (e.g., average, weighted average, median) suitable for comparing a difference between two sets of parameters. The skilled artisan will be knowledgeable of such approaches. In some embodiments, the parameters can include signal processing parameters (e.g., filter zeros and poles, decay constants). However, the parameters can include any suitable parameters.

In some embodiments, determining the difference between the first and second acoustic data at stage 1030 comprises comparing the first client application and the second client application. For example, as described above with respect to FIG. 6, an individual client application can specify whether or not to use global acoustic data (such as global acoustic data 510); and/or whether or not to use client application acoustic data (such as client application acoustic data 520). Process 1000 may determine that a difference between the first and second acoustic data includes whether the first and second client applications use global acoustic data, and/or whether the first and second client applications use client application acoustic data—that is, if the first client application uses global acoustic data and the second client application does not, or vice versa; or if the first client application uses client application acoustic data and the second client application does not, or vice versa.

In some embodiments, determining the difference between the first and second acoustic data at stage 1030 comprises comparing reverberation parameters of the first acoustic data with reverberation parameters of the second acoustic data. This is because in some cases, reverberation processing is particularly resource intensive, such that consolidating acoustic data with similar reverberation characteristics can yield large improvements in computational efficiency.

In some embodiments, determining the difference between the first and second acoustic data at stage 1030 includes comparing characteristics of the first client application to characteristics of the second client application. For example, if the first and second client applications are applications of a similar nature—for instance, if the first and second client applications are both teleconference applications, or music applications, or virtual assistants, or other applications that may have similarities—a difference between the first and second client applications could be considered more (or less) significant than if the first and second client applications were two substantially different applications (e.g., an action game and a mail application). In some embodiments, a state of the client applications could be considered. For example, if both client applications are in similar states of activity (e.g., both applications are paused on menu screens), a difference between them could be determined to be minor.

In some embodiments, determining the difference between the first and second acoustic data at stage 1030 includes determining whether the first and second acoustic data relate to a common acoustic zone. If so, characteristics of that acoustic zone can be compared to determine a difference between the first and second acoustic data.

In some embodiments, the first acoustic data can be applied to a test input to generate a first test signal; and the second acoustic data can be applied to the same test input or a different test input to generate a second test signal. Determining the difference between the first and second acoustic data at stage 1030 can include comparing the first test signal to the second test signal. For example, a cross-correlation of the first test signal and the second test signal can indicate a difference between the first acoustic data and the second acoustic data. Other comparisons of the first test signal and the second test signal (such as using a frequency domain approach) will be apparent to the skilled artisan.

In some embodiments where the first and second client applications are applications of a wearable device, such as an augmented reality or mixed reality device, the device itself can be used to determine the difference between the first and second acoustic data at stage 1030. For example, stage 1030 may consider the output of one or more sensors of the wearable device to determine the difference. In some embodiments, the sensor output can indicate a current location of the wearable device (e.g., where a sensor is a GPS sensor), and a difference between the first and second acoustic data may be considered more or less significant based on the location. In some embodiments, a microphone of the wearable device can be used to detect an ambient noise level, which can be used to determine the difference. Other uses of sensors of the wearable device will be apparent to the skilled artisan.

In some embodiments, determining the difference between the first and second acoustic data at stage 1030 comprises a combination of two or more of the above factors. In some embodiments, some factors may be weighted according to their relative importance. For example, in some acoustic environments, reverberation characteristics may be weighted heavily in determining the difference, because reverberation may be very significant to the user's audio experience and the user may be very susceptible to noticing differences in reverberation characteristics. Other appropriate weightings will be apparent to the skilled artisan.

In some embodiments, determining at stage 1040 whether the difference is sufficiently small or imperceptible comprises determining a threshold, and comparing the difference to the threshold. In some embodiments, the threshold comprises a perceptibility threshold, which can be a numerical value below which two sets of acoustic data are perceptually indistinguishable. (Conversely, in some embodiments, such as described above in which a similarity (rather than a difference) between two acoustic data sets is determined, a threshold may represent a value above which two sets of acoustic data are perceptually indistinguishable.) In some embodiments, the perceptibility threshold can be referred to as a Just Noticeable Difference (JND). As one example, according to the standards document ISO 3382-1 (2009) (“Measurement of Room Acoustic Parameters”), a Just Noticeable Difference (e.g., for reverberation metrics) can be 5 percent. In other examples, a Just Noticeable Difference can be in a range of 6 percent to 39 percent. In some examples, a Just Noticeable Difference can be less than 5 percent. In some embodiments, the threshold can be static and set in advance of performing process 1000, and can be set to any suitable value. In some embodiments, the threshold can be dynamic, and/or may be set during process 1000; during a runtime event (such as processing an audio signal as in process 900), or at some other suitable time. For instance, the threshold may increase or decrease depending on available system resources; that is, the threshold may increase as available system resources decrease (resulting in greater consolidation of acoustic data sets), and the threshold may decrease as available system resources increase (resulting in less consolidation of acoustic data sets). The threshold may be expressed in any units that are appropriate for the difference (or similarity) between the first and second acoustic data sets determined at stage 1030.

In some embodiments, the threshold may be different depending on the identity of the first client application. For instance, if the first client application is an application of particular importance, if the first client application is a particularly audio-centric application, or if the first client application is one that features unique audio characteristics, then the difference threshold for associating the first client application with the second acoustic data (stage 1050) may be lower than it would be otherwise. This represents that, for such client applications, it should be made less likely that the application will be associated with another client application's acoustic data. Similarly, in some embodiments, a client application can be associated with an audio priority level, such that for client applications with high audio priority levels, a difference threshold may be set low; and, conversely, for client applications with low audio priority levels, the difference threshold may be higher. Audio priority levels for an application can be determined for a client application by audio service 600, or in some embodiments can be communicated to the audio service 600 by the client application itself (such as shown in FIG. 6).

In some embodiments, a perceptibility threshold can be determined empirically. For example, a study can be conducted that relates perceptibility threshold values (e.g., for particular client applications) to user-reported indications of audio quality or perceptibility. Appropriate threshold values can be set accordingly.

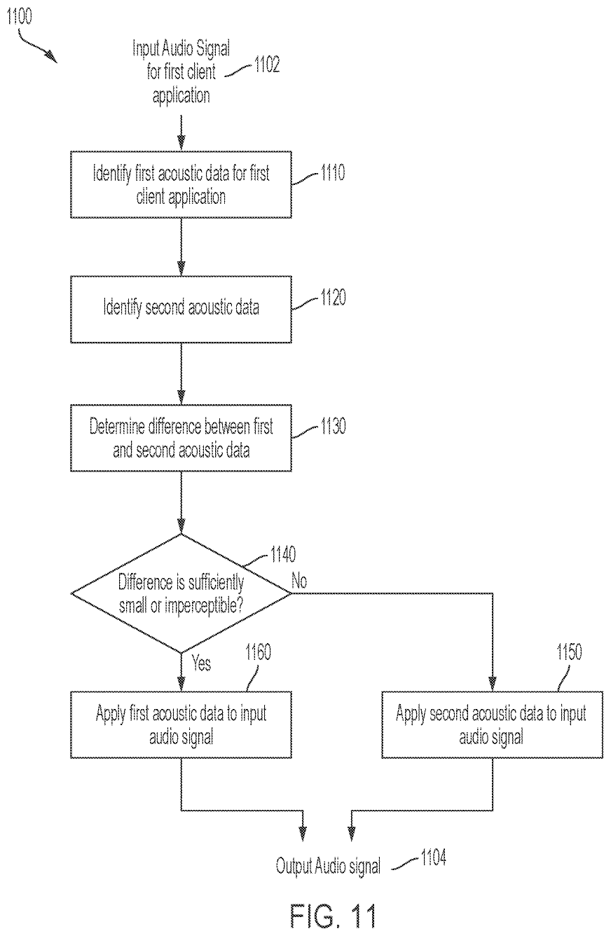

FIG. 11 shows an example process 1100 in which acoustic data is applied to an input audio signal. Process 1100 can be performed by audio service 600, by an acoustic data module 630, by rendering engine 640, or by any other suitable process. In some embodiments, process 1000 is performed by a processor of a wearable device, such as a wearable head device for an augmented reality or mixed reality system.

Process 1100 can be performed at runtime, as an input audio signal 1102 arrives at audio service 600 for processing. In process 1100, the input audio signal 1102 is associated with a client application, and is presented to audio service 600 by the client application (such as described above with respect to FIG. 6). At stage 1110, first acoustic data is identified for the first client application. Stage 1110 can correspond to stage 1010 of process 1000, described above. At stage 1120, second acoustic data is identified. Stage 1120 can correspond to stage 1020 of process 1000, described above. At stage 1130, a difference can be computed between the first acoustic data and the second acoustic data, such as described above. If the difference between the first acoustic data and the second acoustic data is sufficiently small, or sufficiently imperceptible (stage 1140), such as described above, then the second acoustic data can be applied to the input audio signal 1102 (stage 1150) to produce an output audio signal 1104. If the difference between the first acoustic data and the second acoustic data is not sufficiently small, or is not sufficiently imperceptible, then the first acoustic data can be applied to the input audio signal 1102 (stage 1160) to produce the output audio signal 1104. Output audio signal 1104 can be presented to a user, such as via headphones or speakers of a wearable head device.

According to some disclosed embodiments, a method can comprise determining whether a difference between first acoustic data and second acoustic data exceeds a threshold. The first acoustic data is associated with a first client application in communication with an audio service. The second acoustic data is associated with a second client application in communication with the audio service. A first input audio signal associated with the first client application is received via the audio service. In accordance with a determination that the difference does not exceed the threshold, the second acoustic data is applied to the first input audio signal to produce a first output audio signal. In accordance with a determination that the difference exceeds the threshold, the first acoustic data is applied to the first input audio signal to produce the first output audio signal. The first output audio signal is presented to a user of a wearable head device in communication with the audio service. According to some disclosed embodiments, the first acoustic data is associated with a location of the user in a virtual environment; and presenting the first output audio signal comprises presenting the output audio signal via a speaker of the wearable head device, concurrently with presenting a view of the virtual environment via a display of the wearable head device. According to some disclosed embodiments, the method further comprises receiving, via the audio service, a second input audio signal associated with the second client application; applying the second acoustic data to the second input audio signal to produce a second output audio signal; and presenting the second output audio signal to the user of the wearable head device, concurrently with presenting the first output audio signal to the user of the wearable head device. According to some disclosed embodiments, determining whether the difference between the second acoustic data and the first acoustic data exceeds the threshold comprises determining a difference between a first test audio signal and a second test audio signal; the first test audio signal is associated with one or more of the first client application and the first acoustic data; and the second test audio signal is associated with one or more of the second client application and the second acoustic data. According to some disclosed embodiments, determining whether the difference between the second acoustic data and the first acoustic data exceeds the threshold comprises: determining whether the first acoustic data is based on a shared acoustic data; and determining whether the second acoustic data is based on the shared acoustic data. According to some disclosed embodiments, the first acoustic data is based on a shared acoustic data and on a first client-specific acoustic data; the second acoustic data is based on the shared acoustic data and on a second client-specific acoustic data; and determining whether the difference between the second acoustic data and the first acoustic data exceeds the threshold comprises determining a difference between the first client-specific acoustic data and the second client-specific acoustic data. According to some disclosed embodiments, the threshold comprises a perceptual tolerance threshold; the difference between the second acoustic data and the first acoustic data comprises a perceptual difference; and the perceptual tolerance threshold is determined based on an availability of computational resources.

According to some disclosed embodiments, a system can comprise a wearable head device comprising a speaker, and one or more processors configured to perform a method. The method can comprise determining whether a difference between first acoustic data and second acoustic data exceeds a threshold. The first acoustic data is associated with a first client application in communication with an audio service. The second acoustic data is associated with a second client application in communication with the audio service. The audio service is in communication with the wearable head device. A first input audio signal associated with the first client application is received via the audio service. In accordance with a determination that the difference does not exceed the threshold, the second acoustic data is applied to the first input audio signal to produce a first output audio signal. In accordance with a determination that the difference exceeds the threshold, the first acoustic data is applied to the first input audio signal to produce the first output audio signal. The first output audio signal is presented via the speaker. According to some disclosed embodiments, the wearable head device further comprises a display; the first acoustic data is associated with a location of the user in a virtual environment; and presenting the first output audio signal comprises presenting the output audio signal via the speaker, concurrently with presenting a view of the virtual environment via the display. According to some disclosed embodiments, the method further comprises receiving, via the audio service, a second input audio signal associated with the second client application; applying the second acoustic data to the second input audio signal to produce a second output audio signal; and presenting the second output audio signal via the speaker, concurrently with presenting the first output audio signal via the speaker. According to some disclosed embodiments, determining whether the difference between the second acoustic data and the first acoustic data exceeds the threshold comprises determining a difference between a first test audio signal and a second test audio signal; the first test audio signal is associated with one or more of the first client application and the first acoustic data; and the second test audio signal is associated with one or more of the second client application and the second acoustic data. According to some disclosed embodiments, determining whether the difference between the second acoustic data and the first acoustic data exceeds the threshold comprises: determining whether the first acoustic data is based on a shared acoustic data; and determining whether the second acoustic data is based on the shared acoustic data. According to some disclosed embodiments, the first acoustic data is based on a shared acoustic data and on a first client-specific acoustic data; the second acoustic data is based on the shared acoustic data and on a second client-specific acoustic data; and determining whether the difference between the second acoustic data and the first acoustic data exceeds the threshold comprises determining a difference between the first client-specific acoustic data and the second client-specific acoustic data. According to some disclosed embodiments, the threshold comprises a perceptual tolerance threshold; the difference between the second acoustic data and the first acoustic data comprises a perceptual difference; and the perceptual tolerance threshold is determined based on an availability of computational resources.

According to some disclosed embodiments, a non-transitory computer-readable medium stores instructions which, when executed by one or more processors, cause the one or more processors to perform a method. The method can comprise determining whether a difference between first acoustic data and second acoustic data exceeds a threshold. The first acoustic data is associated with a first client application in communication with an audio service. The second acoustic data is associated with a second client application in communication with the audio service. A first input audio signal associated with the first client application is received via the audio service. In accordance with a determination that the difference does not exceed the threshold, the second acoustic data is applied to the first input audio signal to produce a first output audio signal. In accordance with a determination that the difference exceeds the threshold, the first acoustic data is applied to the first input audio signal to produce the first output audio signal. The first output audio signal is presented to a user of a wearable head device in communication with the audio service. According to some disclosed embodiments, the first acoustic data is associated with a location of the user in a virtual environment; and presenting the first output audio signal comprises presenting the output audio signal via a speaker of the wearable head device, concurrently with presenting a view of the virtual environment via a display of the wearable head device. According to some disclosed embodiments, the method further comprises receiving, via the audio service, a second input audio signal associated with the second client application; applying the second acoustic data to the second input audio signal to produce a second output audio signal; and presenting the second output audio signal to the user of the wearable head device, concurrently with presenting the first output audio signal to the user of the wearable head device. According to some disclosed embodiments, determining whether the difference between the second acoustic data and the first acoustic data exceeds the threshold comprises determining a difference between a first test audio signal and a second test audio signal; the first test audio signal is associated with one or more of the first client application and the first acoustic data; and the second test audio signal is associated with one or more of the second client application and the second acoustic data. According to some disclosed embodiments, the first acoustic data is based on a shared acoustic data and on a first client-specific acoustic data; the second acoustic data is based on the shared acoustic data and on a second client-specific acoustic data; and determining whether the difference between the second acoustic data and the first acoustic data exceeds the threshold comprises determining a difference between the first client-specific acoustic data and the second client-specific acoustic data. According to some disclosed embodiments, the threshold comprises a perceptual tolerance threshold; the difference between the second acoustic data and the first acoustic data comprises a perceptual difference; and the perceptual tolerance threshold is determined based on an availability of computational resources.

Although the disclosed examples have been fully described with reference to the accompanying drawings, it is to be noted that various changes and modifications will become apparent to those skilled in the art. For example, elements of one or more implementations may be combined, deleted, modified, or supplemented to form further implementations. Such changes and modifications are to be understood as being included within the scope of the disclosed examples as defined by the appended claims.

What is claimed is:

1. A method comprising:
determining whether a difference between first acoustic data and second acoustic data exceeds a threshold, wherein:
the first acoustic data is associated with a first client application in communication with an audio service, and
the second acoustic data is associated with a second client application in communication with the audio service;
receiving, via the audio service, a first input audio signal associated with the first client application;
in accordance with a determination that the difference does not exceed the threshold, applying the second acoustic data to the first input audio signal to produce a first output audio signal;
in accordance with a determination that the difference exceeds the threshold, applying the first acoustic data to the first input audio signal to produce the first output audio signal; and
presenting the first output audio signal to a user of a wearable head device in communication with the audio service.

2. The method of claim 1, wherein:
the first acoustic data is associated with a location of the user in a virtual environment; and
presenting the first output audio signal comprises presenting the output audio signal via a speaker of the wearable head device, concurrently with presenting a view of the virtual environment via a display of the wearable head device.

3. The method of claim 1, further comprising:
receiving, via the audio service, a second input audio signal associated with the second client application;
applying the second acoustic data to the second input audio signal to produce a second output audio signal; and
presenting the second output audio signal to the user of the wearable head device, concurrently with presenting the first output audio signal to the user of the wearable head device.

4. The method of claim 1, wherein:
determining whether the difference between the second acoustic data and the first acoustic data exceeds the threshold comprises determining a difference between a first test audio signal and a second test audio signal;
the first test audio signal is associated with one or more of the first client application and the first acoustic data; and
the second test audio signal is associated with one or more of the second client application and the second acoustic data.

5. The method of claim 1, wherein:
determining whether the difference between the second acoustic data and the first acoustic data exceeds the threshold comprises:
determining whether the first acoustic data is based on a shared acoustic data; and
determining whether the second acoustic data is based on the shared acoustic data.

6. The method of claim 1, wherein:
the first acoustic data is based on a shared acoustic data and on a first client-specific acoustic data;
the second acoustic data is based on the shared acoustic data and on a second client-specific acoustic data; and
determining whether the difference between the second acoustic data and the first acoustic data exceeds the threshold comprises determining a difference between the first client-specific acoustic data and the second client-specific acoustic data.

7. The method of claim 1, wherein:
the threshold comprises a perceptual tolerance threshold;
the difference between the second acoustic data and the first acoustic data comprises a perceptual difference; and
the perceptual tolerance threshold is determined based on an availability of computational resources.

8. A system comprising:
a wearable head device comprising a speaker; and
one or more processors configured to perform a method comprising:
determining whether a difference between first acoustic data and second acoustic data exceeds a threshold, wherein:
the first acoustic data is associated with a first client application in communication with an audio service,
the second acoustic data is associated with a second client application in communication with the audio service, and
the audio service is in communication with the wearable head device;
receiving, via the audio service, a first input audio signal associated with the first client application;
in accordance with a determination that the difference does not exceed the threshold, applying the second acoustic data to the first input audio signal to produce a first output audio signal;
in accordance with a determination that the difference exceeds the threshold, applying the first acoustic data to the first input audio signal to produce the first output audio signal; and
presenting the first output audio signal via the speaker.

9. The system of claim 8, wherein:
the wearable head device further comprises a display;
the first acoustic data is associated with a location of the user in a virtual environment; and
presenting the first output audio signal comprises presenting the output audio signal via the speaker, concurrently with presenting a view of the virtual environment via the display.

10. The system of claim 8, the method further comprising:
receiving, via the audio service, a second input audio signal associated with the second client application;
applying the second acoustic data to the second input audio signal to produce a second output audio signal; and
presenting the second output audio signal via the speaker, concurrently with presenting the first output audio signal via the speaker.

11. The system of claim 8, wherein:
determining whether the difference between the second acoustic data and the first acoustic data exceeds the threshold comprises determining a difference between a first test audio signal and a second test audio signal;
the first test audio signal is associated with one or more of the first client application and the first acoustic data; and
the second test audio signal is associated with one or more of the second client application and the second acoustic data.

12. The system of claim 8, wherein:
determining whether the difference between the second acoustic data and the first acoustic data exceeds the threshold comprises:
determining whether the first acoustic data is based on a shared acoustic data; and
determining whether the second acoustic data is based on the shared acoustic data.

13. The system of claim 8, wherein:
the first acoustic data is based on a shared acoustic data and on a first client-specific acoustic data;
the second acoustic data is based on the shared acoustic data and on a second client-specific acoustic data; and
determining whether the difference between the second acoustic data and the first acoustic data exceeds the threshold comprises determining a difference between the first client-specific acoustic data and the second client-specific acoustic data.

14. The system of claim 8, wherein:
the threshold comprises a perceptual tolerance threshold;
the difference between the second acoustic data and the first acoustic data comprises a perceptual difference; and
the perceptual tolerance threshold is determined based on an availability of computational resources.

15. A non-transitory computer-readable medium storing instructions which, when executed by one or more processors, cause the one or more processors to perform a method comprising:
determining whether a difference between first acoustic data and second acoustic data exceeds a threshold, wherein:
the first acoustic data is associated with a first client application in communication with an audio service, and
the second acoustic data is associated with a second client application in communication with the audio service;
receiving, via the audio service, a first input audio signal associated with the first client application;
in accordance with a determination that the difference does not exceed the threshold, applying the second acoustic data to the first input audio signal to produce a first output audio signal;
in accordance with a determination that the difference exceeds the threshold, applying the first acoustic data to the first input audio signal to produce the first output audio signal; and
presenting the first output audio signal to a user of a wearable head device in communication with the audio service.

16. The non-transitory computer-readable medium of claim 15, wherein:
the first acoustic data is associated with a location of the user in a virtual environment; and
presenting the first output audio signal comprises presenting the output audio signal via a speaker of the wearable head device, concurrently with presenting a view of the virtual environment via a display of the wearable head device.

17. The non-transitory computer-readable medium of claim 15, the method further comprising:
receiving, via the audio service, a second input audio signal associated with the second client application;
applying the second acoustic data to the second input audio signal to produce a second output audio signal; and
presenting the second output audio signal to the user of the wearable head device, concurrently with presenting the first output audio signal to the user of the wearable head device.

18. The non-transitory computer-readable medium of claim 15, wherein:
determining whether the difference between the second acoustic data and the first acoustic data exceeds the threshold comprises determining a difference between a first test audio signal and a second test audio signal;
the first test audio signal is associated with one or more of the first client application and the first acoustic data; and
the second test audio signal is associated with one or more of the second client application and the second acoustic data.

19. The non-transitory computer-readable medium of claim 15, wherein:
the first acoustic data is based on a shared acoustic data and on a first client-specific acoustic data;
the second acoustic data is based on the shared acoustic data and on a second client-specific acoustic data; and
determining whether the difference between the second acoustic data and the first acoustic data exceeds the threshold comprises determining a difference between the first client-specific acoustic data and the second client-specific acoustic data.

20. The non-transitory computer-readable medium of claim 15, wherein:
the threshold comprises a perceptual tolerance threshold;
the difference between the second acoustic data and the first acoustic data comprises a perceptual difference; and
the perceptual tolerance threshold is determined based on an availability of computational resources.
